(19) United States
(12) Patent Application Publication
(10) Pub. No.: US 2006/0160703 A1
(43) Pub. Date: Jul. 20, 2006

(54) Selective herbicides based on substituted cyclic dicarbonyl compounds and safeners

(76) Inventors: Dieter Feucht, Eschborn (DE); Reiner Fischer, Monheim (DE); Stefan Lehr, Liederbach (DE); Guido Bojack, Wiesbaden (DE); Thomas Auler, Leichlingen (DE); Martin Hills, Idstein (DE); Chris Rosinger, Hofheim (DE); Lothar Willms, Hofheim (DE); Frank Ziemer, Kriftel (DE)

Correspondence Address: BAYER CROPSCIENCE LP;Patent Department, 100 BAYER ROAD, PITTSBURGH, PA, 15205-9741, US

(21) Appl. No.: 10/542,513

(22) PCT Filed: Jan. 7, 2004
(86) PCT No.: PCT/EP04/00038

§ 371 Date: Feb. 21, 2006

(30) Foreign Application Priority Data
Jan. 20, 2003 (DE) 103 01 806.9

(51) Int. Cl. A01N 43/36; A01N 43/56; A01N 43/02; A01N 43/647

(52) U.S. Cl. 504/129; 504/138; 504/139; 504/140

(57) ABSTRACT

The present invention relates to selective herbicidal compositions that comprise an effective amount of an active compound combination comprising
(a) a substituted cyclic dicarbonyl compound of the formula (I) 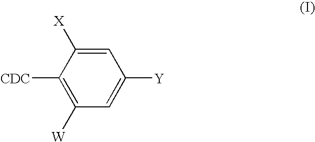 in which W, X, and Y are as defined in the description and CDC represents one of the dicarbonyl radicals mentioned in the disclosure, and (b) at least one crop plant compatibility-improving compound from the group of compounds stated in the disclosure, particularly cloquintocet-mexyl and mefenpyr-diethyl. The invention further relates to the use of these compositions as selective herbicides and to a method for controlling unwanted vegetation using these compositions.

The invention relates to novel selective herbicidal active compound combinations comprising firstly substituted cyclic ketoenols and secondly at least one crop plant compatibility-improving compound, which combinations can be used with particularly good results for the selective control of weeds in various crops of useful plants.

It is known that 4-chloro- and 4-nitro-4-phenylpyrazolyl-3,5-diones (WO 99/20610) have herbicidal action and that 3-halo- and 3-nitro-3-phenyl-substituted pyrrolidine-2,4-diones and 4-oxofuran-2-ones (JP 12 086 628) and chloroketolactams (WO 03/029 213) have acaricidal and insecticidal action.

However, the activity of these compounds and/or their compatibility with crop plants are not under all conditions entirely satisfactory.

Surprisingly, it has now been found that certain substituted cyclic dicarbonyl compounds, when used together with the crop plant compatibility-improving compounds (safeners/antidotes) described below, prevent damage to crop plants extremely well and can be used particularly advantageously as broad-spectrum combination preparations for the selective control of weeds in crops of useful plants, such as, for example, in cereals, but also in corn, soybeans and rice.

The invention provides selective herbicidal compositions comprising an effective amount of an active compound combination comprising,
(a) at least one substituted cyclic dicarbonyl compound of the formula (I) 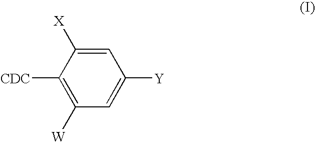
   in which
W represents hydrogen, halogen, alkyl, alkenyl, alkynyl, alkoxy, alkenyloxy, haloalkyl, haloalkoxy, haloalkenyloxy, nitro or cyano,
X represents halogen, alkyl, alkenyl, alkynyl, alkoxy, alkenyloxy, alkylthio, alkylsulfinyl, alkylsulfonyl, haloalkyl, haloalkoxy, haloalkenyloxy, nitro or cyano,
Y represents hydrogen, halogen, alkyl, haloalkyl, haloalkoxy, nitro, cyano or optionally represents substituted phenyl or hetaryl,
CDC represents one of the groups 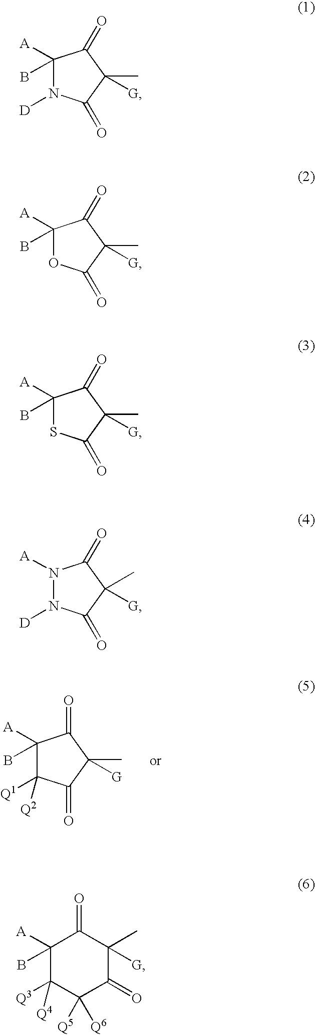
   in which
   A represents hydrogen, in each case optionally halogen-substituted alkyl, alkenyl, alkoxyalkyl, alkylthioalkyl, saturated or unsaturated, optionally substituted cycloalkyl, in which optionally at least one ring atom is replaced by a heteroatom, or in each case optionally halogen-, alkyl-, haloalkyl-, alkoxy-, haloalkoxy-, cyano- or nitro-substituted aryl, arylalkyl or hetaryl,
   B represents hydrogen, alkyl or alkoxyalkyl, or
   A and B together with the carbon atom to which they are attached represent an unsubstituted or substituted cycle which is saturated or unsaturated and optionally contains at least one heteroatom,
   D represents hydrogen or an optionally substituted radical from the group consisting of alkyl, alkenyl, alkynyl, alkoxyalkyl, saturated or unsaturated cycloalkyl, in which optionally one or more ring members are replaced by heteroatoms, arylalkyl, aryl, hetarylalkyl or hetaryl or
   A and D together with the atoms to which they attached represent a cycle which is saturated or unsaturated and optionally contains at least one heteroatom and is unsubstituted or substituted in the A,D-moiety, or
   A and Q¹ together represent alkanediyl or alkenediyl, optionally substituted by hydroxyl, in each case optionally substituted alkyl, alkoxy, alkylthio, cycloalkyl, benzyloxy or aryl, or
   Q¹ represents hydrogen or alkyl,
   Q², Q⁴, Q⁵ and Q⁶ independently of one another represent hydrogen or alkyl,
   Q³ represents hydrogen, alkyl, alkoxyalkyl, alkylthioalkyl, optionally substituted cycloalkyl (in which optionally one methylene group is replaced by oxygen or sulfur) or optionally substituted phenyl, or
   Q³ and Q⁴ together with the carbon atom to which they are attached represent an unsubstituted or substituted cycle which is saturated or unsaturated and optionally contains a heteroatom,
   G represents halogen or nitro,
   including all isomeric forms,
      and
(b) at least one compound which improves crop plant compatibility, from the group of compounds below:

4-dichloroacetyl-1-oxa-4-azaspiro[4.5]-decane (AD-67, MONA4660), 1-dichloro-acetylhexahydro-3,3,8a-trimethylpyrrolo[1,2-a]-pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinolin-8-oxyacetate (cloquintocet-mexyl—cf. also related compounds in EP-A-86750, EP-A-94349, EP-A-191736, EP-A492366), 3-(2-chlorobenzyl)-1-(1-methyl-1-phenylethyl)urea (cumyluron), α-(cyano-methoximino)phenylacetonitrile (cyometrinil), 2,4-dichlorophenoxyacetic acid (2,4-D), 4-(2,4-dichlorophenoxy)butyric acid (2,4-DB), 1-(1-methyl-1-phenylethyl)-3-(4-methylphenyl)-urea (daimuron, dymron), 3,6-dichloro-2-methoxybenzoic acid (dicamba), S-1-methyl-1-phenylethyl piperidine-1-thiocarboxylate (dimepiperate), 2,2-dichloro-N-(2-oxo-2-(2-propenylamino)ethyl)-N-(2-propenyl)acetamide (DKA-24), 2,2-dichloro-N,N-di-2-propenylacetamide (dichlormid), 4,6-dichloro-2-phenyl-pyrimidine (fenclorim), ethyl 1-(2,4-dichlorophenyl)-5-trichloromethyl-1H-1,2,4-triazole-3-carboxylate (fenchlorazole-ethyl—cf. also related compounds in EP-A-174562 and EP-A-346620), phenylmethyl 2-chloro-4-trifluoromethylthiazole-5-carboxylate (flurazole), 4-chloro-N-(1,3-dioxolan-2-ylmethoxy)-α-trifluoro-acetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl—cf. also related compounds in WO-A-95/07897), 1-(ethoxycarbonyl)ethyl 3,6-dichloro-2-methoxybenzoate (lactidichlor), (4-chloro-o-tolyloxy)acetic acid (MCPA), 2-(4-chloro-o-tolyloxy)propionic acid (mecoprop), diethyl 1-(2,4-dichloro-phenyl)-4,5-dihydro-5-methyl-1H-pyrazole-3,5-dicarboxylate (mefenpyr-diethyl—cf. also related compounds in WO-A-91/07874), 2-dichloromethyl-2-methyl-1,3-dioxolane (MG-191), 2-propenyl-1-oxa-4-azaspiro[4.5]decane 4-carbodithioate (MG-838), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), 4-(4-chloro-o-tolyl)butyric acid, 4-(4-chlorophenoxy)butyric acid, diphenylmethoxyacetic acid, methyl diphenylmethoxyacetate, ethyl diphenylmethoxyacetate, methyl 1-(2-chlorophenyl)-5-phenyl-1H-pyrazole-3-carboxylate, ethyl 1-(2,4-dichlorophenyl)-5-methyl-1H-pyrazole-3-carboxylate, ethyl 1-(2,4-dichlorophenyl)-5-isopropyl-1H-pyrazole-3-carboxylate, ethyl 1-(2,4-dichlorophenyl)-5-(1,1-dimethylethyl)-1H-pyrazole-3-carboxylate, ethyl 1-(2,4-dichlorophenyl)-5-phenyl-1H-pyrazole-3-carboxylate (cf. also related compounds in EP-A-269806 and EP-A-333131), ethyl 5-(2,4-di-chlorobenzyl)-2-isoxazoline-3-carboxylate, ethyl 5-phenyl-2-isoxazoline-3-carboxylate, ethyl 5-(4-fluorophenyl)-5-phenyl-2-isoxazoline-3-carboxylate (cf also related compounds in WO-A-91/08202), 1,3-dimethylbut-1-yl 5-chloroquinolin-8-oxyacetate, 4-allyloxybutyl 5-chloroquinolin-8-oxy-acetate, 1-allyloxy-prop-2-yl 5-chloroquinolin-8-oxy-acetate, methyl 5-chloroquinolin-8-oxyacetate, ethyl 5-chloroquinolin-8-oxy-acetate, allyl 5-chloroquinolin-8-oxyacetate, 2-oxoprop-1-yl 5-chloroquinolin-8-oxy-acetate, diethyl 5-chloro-quinolin-8-oxymalonate, diallyl 5-chloroquinolin-8-oxymalonate, diethyl 5-chloroquinolin-8-oxy-malonate (cf. also related compounds in EP-A-582198), 4-carboxychroman-4-ylacetic acid (AC-304415, cf EP-A-613618), 4-chlorophenoxyacetic acid, 3,3′-dimethyl-4-methoxybenzophenone, 1-bromo-4-chloromethylsulfonyl-benzene, 1-[4-(N-2-methoxybenzoylsulfamoyl)phenyl]-3-methyl-urea (alias N-(2-methoxybenzoyl)-4-[(methylaminocarbonyl)amino]-benzenesulfonamide), 1-[4-(N-2-methoxybenzoyl-sulfamoyl)-phenyl]-3,3-dimethyl-urea, 1-[4-(N4,5-dimethylbenzoyl-sulfamoyl)phenyl]-3-methylurea, 1-[4-(N-naphthylsulfamoyl)phenyl]-3,3-dimethylurea, N-(2-methoxy-5-methylbenzoyl)-4-(cyclopropyl-aminocarbonyl)benzenesulfonamide,

and/or one of the following compounds defined by general formulae

of the general formula (IIa) 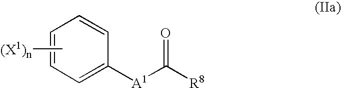
or of the general formula (IIb) 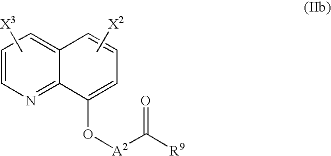
or of the formula (IIc) 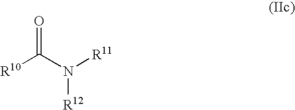
where
n represents a number between 0 and 5,
A¹ represents one of the divalent heterocyclic groupings shown below, 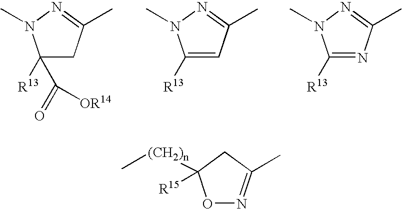
   where
n is as defined above,
A² represents optionally C₁-C₄-alkyl- and/or C₁-C₄-alkoxy-carbonyl-substituted alkanediyl having 1 or 2 carbon atoms,
R⁸ represents hydroxyl, mercapto, amino, C₁-C₆-alkoxy, C₁-C₆-alkylthio, C₁-C₆-alkylamino or di-(C₁-C₄-alkyl)-amino,
R⁹ represents hydroxyl, mercapto, amino, C₁-C₆-alkoxy, C₁-C₆-alkylthio, C₁-C₆-alkylamino or di-(C₁-C₄-alkyl)-amino,
R¹⁰ represents in each case optionally fluorine-, chlorine- and/or bromine-substituted C₁-C₄-alkyl,
R¹¹ represents hydrogen, in each case optionally fluorine-, chlorine- and/or bromine-substituted C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, or optionally fluorine-, chlorine- and/or bromine- or C₁-C₄-alkyl-substituted phenyl,
R¹² represents hydrogen, in each case optionally fluorine-, chlorine- and/or bromine-substituted C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, or optionally fluorine-, chlorine- and/or bromine- or C₁-C₄-alkyl-substituted phenyl, or together with R¹¹ represents C₃-C₆-alkanediyl or C₂-C₅-oxaalkanediyl, each of which is optionally substituted by C₁-C₄-alkyl, phenyl, furyl, a fused-on benzene ring or by two substituents which together with the C atom to which they are attached form a 5- or 6-membered carbocycle,
R¹³ represents hydrogen, cyano, halogen, or represents in each case optionally fluorine-, chlorine- and/or bromine-substituted C₁-C₄-alkyl, C₃-C₆-cycloalkyl or phenyl,
R¹⁴ represents hydrogen, optionally hydroxyl-, cyano-, halogen- or C₁-C₄-alkoxy-substituted C₁-C₆-alkyl, C₃-C₆-cycloalkyl or tri-(C₁-C₄-alkyl)-silyl,
R¹⁵ represents hydrogen, cyano, halogen, or represents in each case optionally fluorine-, chlorine- and/or bromine-substituted C₁-C₄-alkyl, C₃-C₆-cycloalkyl or phenyl,
X¹ represents nitro, cyano, halogen, C₁-C₄-alkyl, C₁-C₄-haloalkyl, C₁-C₄-alkoxy or C₁-C₄-haloalkoxy,
X² represents hydrogen, cyano, nitro, halogen, C₁-C₄-akyl, C₁-C₄-haloalkyl, C₁-C₄-alkoxy or C₁-C₄-haloalkoxy,
X³ represents hydrogen, cyano, nitro, halogen, C₁-C₄-alkyl, C₁-C₄-haloalkyl, C₁-C₄-alkoxy or C₁-C₄-haloalkoxy,
   and/or the following compounds defined by general formulae
   of the general formula (IId) 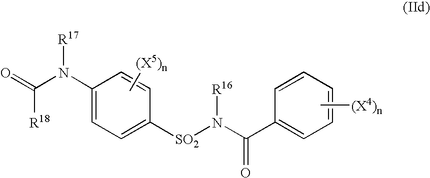
   or of the general formula (IIe) 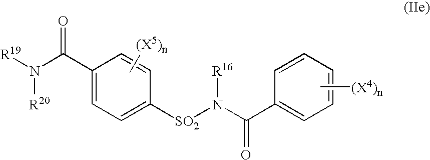
   where
n represents a number between 0 and 5,
R¹⁶ represents hydrogen or C₁-C₄-alkyl,
R¹⁷ represents hydrogen or C₁-C₄-alkyl,
R¹⁸ represents hydrogen, in each case optionally cyano-, halogen- or C₁-C₄-alkoxy-substituted C₁-C₆-alkyl, C₁-C₆-alkoxy, C₁-C₆-allylthio, C₁-C₆-alkylamino or di-(C₁-C₄-alkyl)-amino, or in each case optionally cyano-, halogen- or C₁-C₄-alkyl-substituted C₃-C₆-cycloalkyl, C₃-C₆-cycloalkyloxy, C₃-C₆-cycloalkylthio or C₃-C₆-cycloalkylamino,
R¹⁹ represents hydrogen, optionally cyano-, hydroxyl-, halogen- or C₁-C₄-alkoxy-substituted C₁-C₆-alkyl, in each case optionally cyano- or halogen-substituted C₃-C₆-alkenyl or C₃-C₆-alkynyl, or optionally cyano-, halogen- or C₁-C₄-alkyl-substituted C₃-C₆-cycloalkyl,
R²⁰ represents hydrogen, optionally cyano-, hydroxyl-, halogen- or C₁-C₄-alkoxy-substituted C₁-C₆-alkyl, in each case optionally cyano- or halogen-substituted C₃-C₆-alkenyl or C₃-C₆-alkynyl, optionally cyano-, halogen- or C₁-C₄-alkyl-substituted C₃-C₆-cycloalkyl, or optionally nitro-, cyano-, halogen-, C₁-C₄-alkyl-, C₁-C₄-haloalkyl-, C₁-C₄-alkoxy- or C₁-C₄-halooalkoxy-substituted phenyl, or together with R¹⁹ represents in each case optionally C₁-C₄-alkyl-substituted C₂-C₆-alkanediyl or C₂-C₅-oxaalkanediyl,
X⁴ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy or C₁-C₄-haloalkoxy, and
X⁵ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy or C₁-C₄-haloalkoxy.

In the definitions, the hydrocarbon chains, such as in alkyl or alkanediyl, are in each case straight-chain or branched—including in combination with heteroatoms, such as in alkoxy.

Depending inter alia on the nature of the substituents, the compounds of the formula (I) can be present as geometrical and/or optical isomers or isomer mixtures of varying composition which, if appropriate, may be separated in a customary manner. The present invention provides both the pure isomers and the isomer mixtures, and also their use and compositions comprising them. Hereinbelow, for the sake of simplicity, only compounds of the formula (I) are referred to in each case, although what is meant are both the pure compounds and, if appropriate, also mixtures having different proportions of isomeric compounds.

Taking into account the meanings (1) to (6) of the group CDC, the following principal structures (I-1) to (I-6) result: 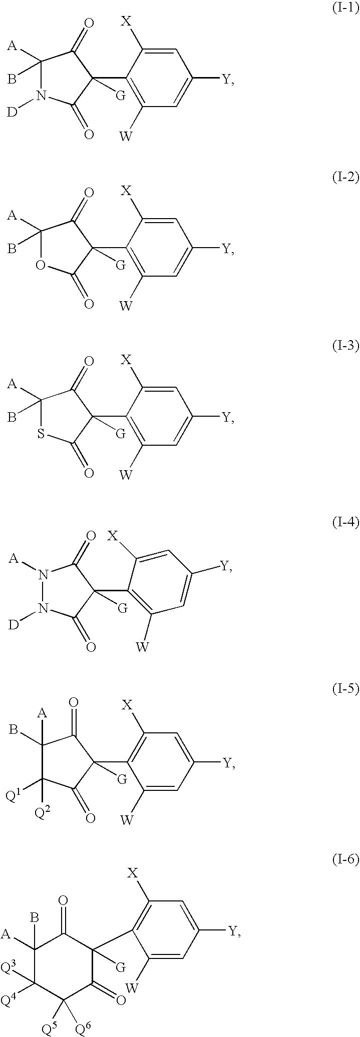
in which

A, B, D, G, Q¹, Q², Q³, Q⁴, Q⁵, Q⁶, W, X and Y are as defined above.

The formula (I) provides a general definition of the substituted cyclic ketoenols according to the invention in the herbicidal compositions. Preferred substituents or ranges of the radicals given for the formulae mentioned above and below are illustrated below:
W preferably represents hydrogen, halogen, C₁-C₆-alkyl, C₁-C₆-haloalkyl or C₁-C₆-alkoxy.
X preferably represents halogen, C₁-C₆-alkyl, C₂-C₆-alkenyl, C₂-C₆-alkynyl, C₁-C₆-haloalkyl, C₁-C₆-alkoxy, C₃-C₆-alkenyloxy, C₁-C₆-haloalkoxy, C₃-C₆-haloalkenyloxy, nitro or cyano.
Y preferably represents hydrogen, halogen, C₁-C₄-alkyl, C₁-C₂-haloalkyl, C₁-C₂-haloalkoxy, cyano or represents one of the radicals 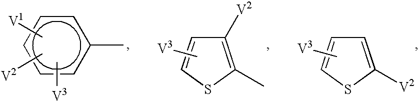
   in which
V¹ represents hydrogen, halogen, C₁-C₁₂-alkyl, C₁-C₆-alkoxy, C₁-C₄-haloalkyl, C₁-C₄-haloalkoxy, nitro or cyano,
V² and V³ independently of one another represent hydrogen, halogen, C₁-C₆-alkyl, C₁-C₆-alkoxy, C₁-C₄-haloalkyl or C₁-C₄-haloalkoxy.
CDC preferably represents one of the groups 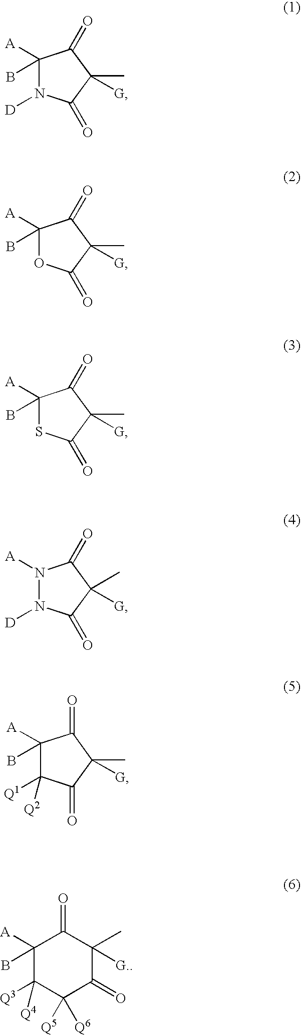
A preferably represents hydrogen or in each case optionally halogen-substituted C₁-C₁₂-alkyl, C₃-C₈-alkenyl, C₁-C₁₀-alkoxy-C₁-C₈-alkyl, C₁-C₁₀-akylthio-C₁-C₆-alkyl, optionally halogen-, C₁-C₆-alkyl- or C₁-C₆-alkoxy-substituted C₃-C₈-cycloalkyl, in which optionally one or two not directly adjacent ring members are replaced by oxygen and/or sulfur or represents in each case optionally halogen-, C₁-C₆-alkyl-, C₁-C₆-haloalkyl-, C₁-C₆-alkoxy-, C₁-C₆-haloalkoxy-, cyano- or nitro-substituted phenyl or phenyl-C₁-C₆-alkyl.
B preferably represents hydrogen, C₁-C₁₂-alkyl or C₁-C₈-alkoxy-C₁-C₆-alkyl, or
A, B and the carbon atom to which they are attached preferably represent saturated C₃-C₁₀-cycloalkyl or unsaturated C₅-C₁₀-cycloalkyl in which optionally one ring member is replaced by oxygen or sulfur and which are optionally mono- or disubstituted by C₁-C₈-alkyl, C₃-C₁₀-cycloalkyl, C₁-C₈-haloalkyl, C₁-C₈-alkoxy, C₁-C₈-alkylthio, halogen or phenyl, or
A, B and the carbon atom to which they are attached preferably represent C₅-C₆-cycloalkyl which is substituted by an alkylenedioxyl or by an alkylenedithioyl group or by an alkylenediyl group which optionally contains one or two not directly adjacent oxygen and/or sulfur atoms and which is optionally substituted by C₁-C₄-alkyl, which alkylenedioxyl, alkylenedithioyl or alkylenediyl group forms, together with the carbon atom to which it is attached, a further five- to eight-membered ring, or
A, B and the carbon atom to which they are attached preferably represent C₃-C₈-cycloalkyl or C₅-C₈-cycloalkenyl in which two substituents together with the carbon atoms to which they are attached represent in each case optionally C₁-C₆-alkyl-, C₁-C₆-alkoxy- or halogen-substituted C₂-C₆-alkanediyl, C₂-C₆-alkenediyl or C₄-C₆-alkanedienediyl in which optionally one methylene group is replaced by oxygen or sulfur.
D preferably represents hydrogen, in each case optionally halogen-substituted C₁-C₁₂-alkyl, C₃-C₈-alkenyl, C₃-C₈-alkynyl, C₁-C₁₀-alkoxy-C₂-C₈-alkyl, optionally halogen-, C₁-C₄-alkyl-, C₁-C₄-alkoxy- or C₁-C₄-haloalkyl-substituted C₃-C₈-cycloalkyl in which optionally one ring member is replaced by oxygen or sulfur or in each case optionally halogen-, C₁-C₆-alkyl-, C₁-C₆-haloalkyl-, C₁-C₆-alkoxy-, C₁-C₆-haloalkoxy-, cyano- or nitro-substituted phenyl or phenyl-C₁-C₆-alkyl.
A and D together preferably represent in each case optionally substituted C₃-C₆-alkanediyl or C₃-C₆-alkenediyl in which optionally one methylene group is replaced by a carbonyl group, oxygen or sulfur, and
   possible substituents being in each case:
   halogen, hydroxyl, mercapto or in each case optionally halogen-substituted C₁-C₁₀-alkyl or C₁-C₆-alkoxy, or a further C₃-C₆-alkanediyl grouping, C₃-C₆-alkenediyl grouping or a butadienyl grouping which is optionally substituted by C₁-C₆-alkyl or in which optionally two adjacent substituents together with the carbon atoms to which they are attached form a further saturated or unsaturated cycle having 5 or 6 ring atoms (in case of the compound of the formula (I-1), A and D together with the atoms to which they are attached then preferably represent, for example, the groups AD-1 to AD-10 mentioned further below) which may contain oxygen or sulfur.
A and Q¹ together preferably represent C₃-C₆-alkanediyl or C₄-C₆-alkenediyl which is furthermore bridged by a C₁-C₂-alkanediyl group or by an oxygen atom, each of which radicals is optionally mono- or disubstituted by identical or different halogens, by C₁-C₁₀-alkyl, C₁-C₆-alkoxy, C₁-C₆-alkylthio, C₃-C₇-cycloalkyl each of which is optionally mono- to trisubstituted by identical or different halogens, or by benzyloxy or phenyl, each of which is optionally mono- to trisubstituted by identical or different substituents from the group consisting of halogen, C₁-C₆-alkyl and C₁-C₆-alkoxy, or
Q¹ preferably represents hydrogen or C₁-C₄-alkyl.
Q², Q⁴, Q⁵ and Q⁶ independently of one another preferably represent hydrogen or C₁-C₄-alkyl.
Q³ preferably represents hydrogen, C₁-C₆-alkyl, C₁-C₆-alkoxy-C₁-C₂-alkyl, C₁-C₆-alkylthio-C₁-C₂-alk-yl, optionally halogen-, C₁-C₄-alkyl- or C₁-C₄-alkoxy-substituted C₃-C₈-cycloalkyl in which optionally one methylene group is replaced by oxygen or sulfur or represents optionally halogen-, C₁-C₄-allyl-, C₁-C₄-alkoxy-, C₁-C₂-haloalkyl-, C₁-C₂-haloalkoxy-, cyano- or nitro-substituted phenyl, or
Q³ and Q⁴ together with the carbon atom to which they are attached preferably represent an optionally C₁-C₄-alkyl-, C₁-C₄-alkoxy- or C₁-C₄-alkoxy- or C₁-C₂-haloalkyl-substituted C₃-C₇-ring in which optionally one ring member is replaced by oxygen or sulfur.
G preferably represents chlorine, bromine or nitro.

In the radical definitions mentioned as being preferred, halogen represents fluorine, chlorine, bromine and iodine, in particular fluorine, chlorine and bromine.
W particularly preferably represents hydrogen, chlorine, bromine, C₁-C₃-alkyl or C₁-C₃-alkoxy.
X particularly preferably represents chlorine, bromine, C₁-C₄-alkyl, C₁-C₄-alkoxy, C₁-C₃-haloalkyl, C₁-C₃-haloalkoxy or cyano.
Y particularly preferably represents hydrogen, chlorine, bromine, C₁-C₂-alkyl, trifluoromethyl or represents the radical 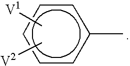
V¹ particularly preferably represents hydrogen, fluorine, chlorine, bromine, C₁-C₆-alkyl, C₁-C₄-alkoxy, C₁-C₂-haloalkyl, C₁-C₂-haloalkoxy, nitro or cyano.
V² particularly preferably represents hydrogen, fluorine, chlorine, bromine, C₁-C₄-alkyl, C₁-C₄-alkoxy, C₁-C₂-haloalkyl or C₁-C₂-haloalkoxy.
CDC particularly preferably represents one of the groups 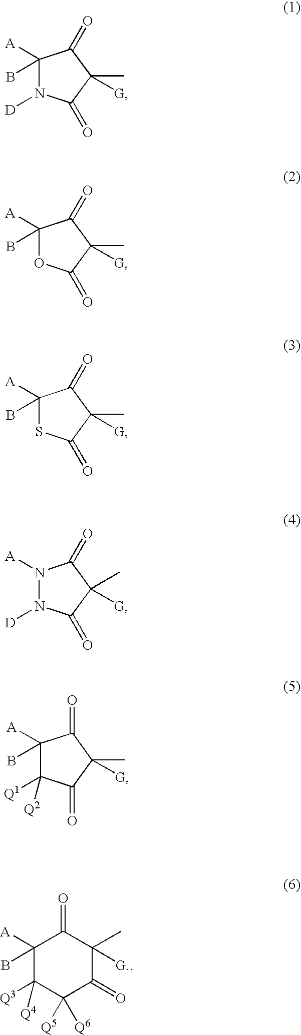
A particularly preferably represents hydrogen, represents C₁-C₆-alkyl or C₁-C₄-alkoxy-C₁-C₂-allyl, each of which is optionally mono- to trisubstituted by fluorine or chlorine, or represents C₃-C₇-cycloalkyl which is optionally mono-to disubstituted by fluorine, chlorine, C₁-C₂-alkyl or C₁-C₂-alkoxy.
B particularly preferably represents hydrogen or C₁-C₆-alkyl, or
A, B and the carbon atom to which they are attached particularly preferably represent saturated C₃-C₇-cycloalkyl in which optionally one ring member is replaced by oxygen or sulfur and which is optionally monosubstituted by C₁-C₄-alkyl, C₁-C₂-haloalkyl or C₁-C₄-alkoxy, with the proviso that Q³ in this case particularly preferably represents hydrogen or methyl, or
A, B and the carbon atom to which they are attached particularly preferably represent C₅-C₆-cycloalkyl which is substituted by an alkylenediyl or by an alkylenedioxyl group which optionally contains one or two not directly adjacent oxygen or sulfur atoms and which is optionally substituted by methyl or ethyl and which together with the carbon atom to which it is attached forms a further five- or six-membered ring, with the proviso that Q³ in this case particularly preferably represents hydrogen or methyl, or
A, B and the carbon atom to which they are attached particularly preferably represent C₃-C₆-cycloalkyl or C₅-C₆-cycloalkenyl in which two substituents together with the carbon atoms to which they are attached represent butadienediyl or C₂-C₄-alkanediyl or C₂-C₄-alkenediyl in which optionally one methylene group is replaced by oxygen and which are in each case optionally monosubstituted by methyl or methoxy, with the proviso that Q³ in this case particularly preferably represents hydrogen or methyl.
D particularly preferably represents hydrogen, represents C₁-C₆-alkyl, C₃-C₆-alkenyl, C₁-C₄-alkoxy-C₂-C₃-alkyl, each of which is optionally mono- to trisubstituted by fluorine or chlorine, represents C₃-C₇-cycloalkyl which is optionally monosubstituted by C₁-C₂-alkyl, C₁-C₂-alkoxy or trifluoromethyl and in which optionally one methylene group is replaced by oxygen or sulfur or (but not in the case of the compounds of the formulae (1-1)) represents phenyl, pyridyl or benzyl, each of which is optionally mono- to disubstituted by fluorine, chlorine, bromine, C₁-C₄-alkyl, C₁-C₂-haloalkyl, C₁-C₄-alkoxy or C₁-C₂-haloalkoxy, or
A and D together particularly preferably represent optionally substituted C₃-C₅-alkanediyl in which one methylene group may be replaced by oxygen or sulfur, a possible substituent being C₁-C₂-alkyl, or
A and D (in the case of compounds of the formula (I-1)) together with the atoms to which the are attached particularly preferably represent one of the groups AD-1 to AD-10: 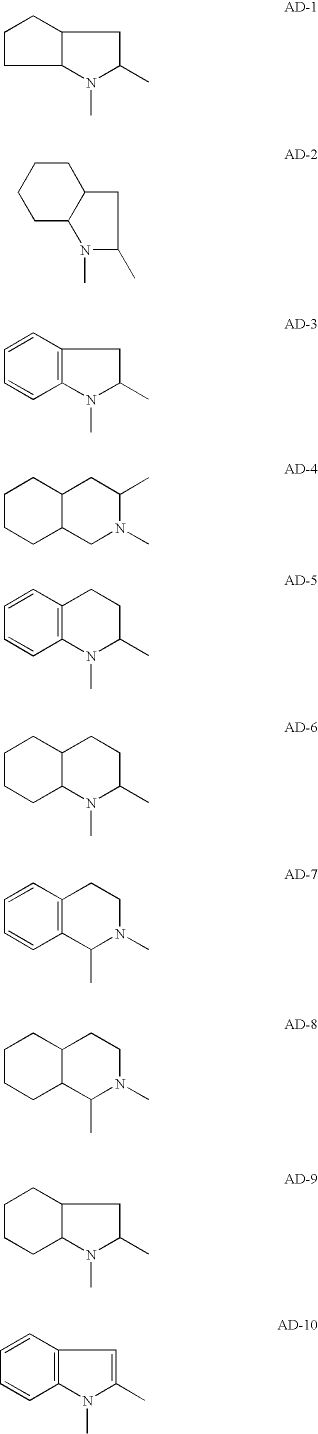
A and Q¹ together particularly preferably represent C₃-C₄-alkanediyl or C₃-C₄-alkenediyl, each of which is optionally mono- or disubstituted by identical or different substituents from the group consisting of C₁-C₂-alkyl or C₁-C₂-alkoxy, or
Q¹ particularly preferably represents hydrogen.
Q² particularly preferably represents hydrogen.
Q⁴, Q⁵ and Q⁶ independently of one another particularly preferably represent hydrogen or C₁-C₂-alkyl.
Q³ particularly preferably represents hydrogen, C₁-C₄-alkyl, C₁-C₄-alkoxy-C₁-C₂-alkyl, C₁-C₄-alkylthio-C₁-C₂-alkyl or optionally methyl- or methoxy-substituted C₃-C₆-cycloalkyl in which optionally one methylene group is replaced by oxygen or sulfur, or
Q³ and Q⁴ together with the carbon to which they are attached particularly preferably represent a saturated C₅-C₆-ring which is optionally mono- to disubstituted by C₁-C₄-alkyl or C₁-C₄-alkoxy and in which optionally one ring member is replaced by oxygen or sulfur,
   with the proviso that A in this case particularly preferably represents hydrogen or methyl.
G particularly preferably represents chlorine or nitro.

In the radical definitions mentioned as being particularly preferred, halogen represents fluorine, chlorine, bromine and iodine, in particular fluorine, chlorine and bromine.
W very particularly preferably represents hydrogen, chlorine, bromine, methyl, ethyl, methoxy or ethoxy.
X very particularly preferably represents chlorine, bromine, methyl, ethyl, propyl, methoxy, ethoxy, trifluoromethyl, difluoromethoxy, trifluoromethoxy or cyano.
Y very particularly preferably represents hydrogen, chlorine, bromine, methyl, trifluoromethyl or represents the radical 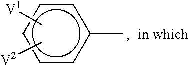
V¹ very particularly preferably represents hydrogen, fluorine, chlorine, bromine, methyl, ethyl, tert-butyl, methoxy, trifluoromethyl or trifluoromethoxy.
V² very particularly preferably represents hydrogen, fluorine, chlorine, methyl, methoxy or trifluoromethyl.
CDC very particularly preferably represents one of the groups 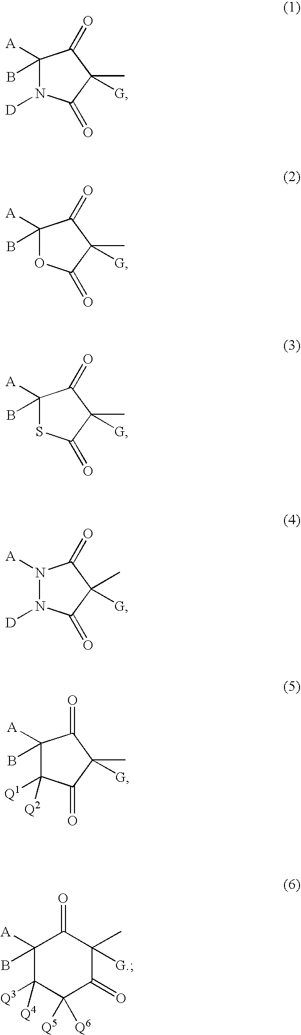
A very particularly preferably represents hydrogen, represents C₁-C₄-akyl or C₁-C₂-alkoxy-C₁-C₂-allyl, each of which is optionally mono- to trisubstituted by fluorine, represents C₃-C₆-cycloalkyl which is optionally monosubstituted by fluorine, methyl or methoxy.
B very particularly preferably represents hydrogen, methyl or ethyl, or
A, B and the carbon atom to which they are attached very particularly preferably represent saturated C₅-C₆-cycloalkyl in which optionally one ring member is replaced by oxygen and which is optionally monosubstituted by methyl, trifluoromethyl, methoxy, ethoxy, propoxy, butoxy or isobutoxy, with the proviso that Q³ in this case very particularly preferably represents hydrogen, or
A, B and the carbon atom to which they are attached very particularly preferably represent C₅-C₆-cycloalkyl which is substituted by an alkylene dioxyl group which contains two not directly adjacent oxygen atoms, with the proviso that Q³ in this case very particularly preferably represents hydrogen,
D very particularly preferably represents hydrogen, represents C₁-C₄-alkyl, C₃-C₄-alkenyl, C₁-C₂-alkoxy-C₂-C₃-alkyl or C₃-C₆-cycloalkyl in which optionally one methylene group is replaced by oxygen or sulfur, each of which radicals is optionally mono- to trisubstituted by fluorine, or (but not in the case of the compounds of the formulae (I-1)) represents phenyl or pyridyl, each of which is optionally mono- to disubstituted by fluorine, chlorine, bromine, methyl, ethyl, n-propyl, isopropyl, methoxy, ethoxy, trifluoromethyl or trifluoromethoxy, or
A and D together very particularly preferably represent optionally substituted C₃-C₅-alkanediyl in which optionally one carbon atom is replaced by oxygen or sulfur and which is optionally mono- or disubstituted by methyl, or
A and D (in the case of the compounds of the formula (I-1)) together with the atoms to which they are attached represent the group: 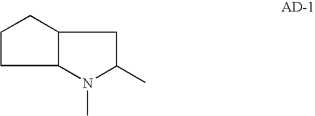
A and Q¹ together very particularly preferably represent C₃-C₄-alkanediyl which is optionally mono- or disubstituted by methyl or methoxy, or
Q¹ very particularly preferably represents hydrogen.
Q² very particularly preferably represents hydrogen.
Q⁴, Q⁵ and Q⁶ independently of one another very particularly preferably represent hydrogen or methyl.
Q³ very particularly preferably represents hydrogen, methyl, ethyl or C₃-C₆-cycloalkyl, or
Q³ and Q⁴ together with the carbon to which they are attached very particularly preferably represent a saturated C₅-C₆-ring which is optionally monosubstituted by methyl or methoxy and in which optionally one ring member is replaced by oxygen or sulfur, with the proviso that A in this case very particularly preferably represents hydrogen.
G very particularly preferably represents chlorine and nitro.

The general or preferred radical definitions or illustrations given above can be combined with one another as desired, i.e. including combinations between the respective ranges and preferred ranges.

Preference according to the invention is given to the compounds of the formula (I) which contain a combination of the meanings given above as being preferred (preferable).

Particular preference according to the invention is given to the compounds of the formula (I) which contain a combination of the meanings given above as being particularly preferred.

Very particular preference according to the invention is given to the compounds of the formula (I) which contain a combination of the meanings given above as being very particularly preferred.

Saturated or unsaturated hydrocarbon radicals, such as alkyl or alkenyl, can in each case be straight-chain or branched as far as this is possible, including in combination with heteroatoms, such as, for example, in alkoxy.

Unless indicated otherwise, optionally substituted radicals can be mono- or polysubstituted, where in the case of polysubstitutions the substituents can be identical or different.

In addition to the compounds mentioned in the examples, the following compounds of the formula (I-1) may be specifically mentioned:

TABLE 1

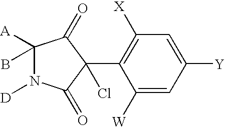

| A | B | D |
|---|---|---|
| CH₃ | CH₃ | H |
| C₂H₅ | CH₃ | H |
| C₃H₇ | CH₃ | H |
| i-C₃H₇ | CH₃ | H |
| 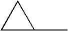 | CH₃ | H |

| | |
|---|---|
| —(CH₂)₄ | H |
| —(CH₂)₅— | H |
| —(CH₂)₂—O—(CH₂)₂— | H |
| —CH₂—O—(CH₂)₃— | H |
| —CH₂—CHCH₃—(CH₂)₃— | H |
| —(CH₂)₂—CHCH₃—(CH₂)₂— | H |
| —(CH₂)₂—CHOCH₃—(CH₂)₂— | H |
| —(CH₂)₂—CHOC₂H₅—(CH₂)₂— | H |
| —(CH₂)₂—C(CH₃)₂—(CH₂)₂— | H |

W = CH₃, X = CH₃, Y = CH₃.

Table 2: A, B and D as stated in Table 1
W═CH₃; X═CH₃; Y═Cl.

Table 3: A, B and D as stated in Table 1
W═CH₃; X═CH₃; Y═Br.

Table 4: A, B and D as stated in Table 1
W═C₂H₅; X═CH₃; Y═Cl.

Table 5: A, B and D as stated in Table 1
W═C₂H₅; X═CH₃; Y═Br.

Table 6: A, B and D as stated in Table 1
W═C₂H₅; X═C₂H₅; Y═Cl.

Table 7: A, B and D as stated in Table 1
W═C₂H₅; X═C₂H₅; Y═Br.

Table 8: A, B and D as stated in Table 1
W═CH₃; X═Cl; Y═Cl.

Table 9: A, B and D as stated in Table 1
W═CH₃; X═Br; Y═Br.

Table 10: A, B and D as stated in Table 1
W═CH₃; X═Cl; Y═Br.

Table 11: A, B and D as stated in Table 1
W═CH₃; X═Br; Y═Cl.

Table 12: A, B and D as stated in Table 1
W═C₂H₅; X═Cl; Y═C1.

Table 13: A, B and D as stated in Table 1
W═C₂H₅; X═Br; Y═Br.

Table 14: A, B and D as stated in Table 1
W═C₂H₅; X═Cl; Y═Br.

Table 15: A, B and D as stated in Table 1
W═C₂H₅; X═Br; Y═Cl.

Table 16: A, B and D as stated in Table 1
W═CH₃; X═CH₃; Y═(4-C₁-C₆H₄).

Table 17: A, B and D as stated in Table 1
W═CH₃; X═Cl; Y═(4-Cl—C₆H₄).

Table 18: A, B and D as stated in Table 1
W═C₂H₅; X═CH₃; Y═(4-Cl-CHL).

Table 19: A, B and D as stated in Table 1
W═C₂H₅; X═Cl; Y═(4-C₁-C₆H₄).

Table 20: A, B and D as stated in Table 1
W═C₂H₅; X═C₂H₅; Y═(4-C₁-C₆H₄).

Table 21: A, B and D as stated in Table 1
W═C₂H₅; X═C₂H₅; Y═CH₃.

Table 22: A, B and D as stated in Table 1
W═C₂H₅; X═CH₃; Y═CH₃.

Table 23: A, B and D as stated in Table 1
W═C₂H₅; X═Br; Y═CH₃.

In addition to the compounds mentioned in the preparation examples, the following compounds of the formula (I-2-a) may be specifically mentioned:

TABLE 23

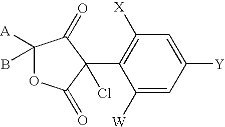

| A | B |
|---|---|
| CH₃ | CH₃ |
| C₂H₅ | CH₃ |
| C₃H₇ | CH₃ |
| i-C₃H₇ | CH₃ |

—(CH₂)₅—
—(CH₂)₂—O—(CH₂)₂—
—CH₂—O—(CH₂)₃—
—CH₂—CHCH₃—(CH₂)₃—
—(CH₂)₂—CHCH₃—(CH₂)₂—
—(CH₂)₂—CHOCH₃—(CH₂)₂—
—(CH₂)₂—CHOC₂H₅—(CH₂)₂—
W = CH₃, X = CH₃, Y = CH₃

Table 24: A and B as stated in Table 23
W═CH₃; X═CH₃; Y═Cl.

Table 25: A and B as stated in Table 23
W═CH₃; X═CH₃; Y═Br.

Table 26: A and B as stated in Table 23
W═C₂H₅; X═CH₃; Y═Cl.

Table 27: A and B as stated in Table 23
W═C₂H₅; X═CH₃; Y═Br.

Table 28: A and B as stated in Table 23
W═C₂H₅; X═C₂H₅; Y═Cl.

Table 29: A and B as stated in Table 23
W═C₂H₅; X═C₂H₅; Y═Br.

Table 30: A and B as stated in Table 23
W═CH₃; X═CH₃; Y═(4-C₆-C₄).

Table 31: A and B as stated in Table 23
W═CH₃; X═C₂H₅; Y═(4-C₆-C₄).

Table 32: A and B as stated in Table 23
W═C₂H₅; X═C₂H₅; Y═(4-Cl—C₆H₄).

Table 33: A and B as stated in Table 23
W═Cl; X═CH₃; Y═(4-Cl—C₆H₄).

Table 34: A and B as stated in Table 23
W═Cl; X═C₂H₅; Y═(4-C₁-C₆H₄).

Table 35: A and B as stated in Table 23
W═C₂H₅; X═C₂H₅; Y═CH₃.

Table 36: A and B as stated in Table 23
W═C₂H₅; X═CH₃; Y═CH₃.

The compounds of the formula (I) are known (cf. WO 03/029 213), and/or can be prepared by processes known per se. Compounds of the formula (I) and their preparation are also described in the as yet unpublished German patent applications DE 102 490 55, DE 103 018 05 and DE 103 374 96.

Preferred meanings of the groups listed above in connection with the crop plant compatibility-improving compounds (“herbicide safeners”) of the formulae (IIa), (IIb), (IIc), (IId) and (IIe) are defined below.
n preferably represents the numbers 0, 1, 2, 3 or 4.
A¹ preferably represents one of the divalent heterocyclic groupings shown below 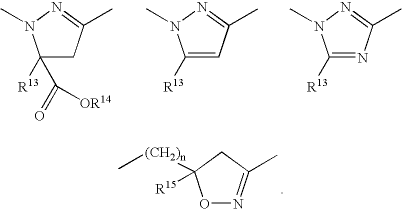
A² preferably represents in each case optionally methyl-, ethyl-, methoxycarbonyl- or ethoxycarbonyl-substituted methylene or ethylene.
R⁸ preferably represents hydroxyl, mercapto, amino, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino.
R⁹ preferably represents hydroxyl, mercapto, amino, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino.
R¹⁰ preferably represents in each case optionally fluorine-, chlorine- and/or bromine-substituted methyl, ethyl, n- or i-propyl.
R¹¹ preferably represents hydrogen, in each case optionally fluorine- and/or chlorine-substituted methyl, ethyl, n- or i-propyl, n-, i-, s- or t-butyl, propenyl, butenyl, propynyl or butynyl, methoxymethyl, ethoxymethyl, methoxyethyl, ethoxyethyl, dioxolanylmethyl, ftuyl, turylmethyl, thienyl, thiazolyl, piperidinyl, or optionally fluorine-, chlorine-, methyl-, ethyl-, n- or i-propyl-, n-, i-, s- or t-butyl-substituted phenyl.
R¹² preferably represents hydrogen, in each case optionally fluorine- and/or chlorine-substituted methyl, ethyl, n- or i-propyl, n-, i-, s- or t-butyl, propenyl, butenyl, propynyl or butynyl, methoxymethyl, ethoxymethyl, methoxyethyl, ethoxyethyl, dioxolanylmethyl, furyl, furylmethyl, thienyl, thiazolyl, piperidinyl, or optionally fluorine-, chlorine-, methyl-, ethyl-, n- or i-propyl-, n-, i-, s- or t-butyl-substituted phenyl, or together with R¹⁷ represents one of the radicals —CH₂—O—CH₂—CH₂— and —CH₂—CH₂—O—CH₂—CH₂-, which are optionally substituted by methyl, ethyl, furyl, phenyl, a fused-on benzene ring or by two substituents which together with the C atom to which they are attached form a 5- or 6-membered carbocycle.
R¹³ preferably represents hydrogen, cyano, fluorine, chlorine, bromine, or represents in each case optionally fluorine-, chlorine- and/or bromine-substituted methyl, ethyl, n- or i-propyl, cyclopropyl, cyclobutyl, cyclopentyl, cyclohexyl or phenyl.
R¹⁴ preferably represents hydrogen, optionally hydroxyl-, cyano-, fluorine-, chlorine-, methoxy-, ethoxy-, n- or i-propoxy-substituted methyl, ethyl, n- or i-propyl, n-, i-, s- or t-butyl.
R¹⁵ preferably represents hydrogen, cyano, fluorine, chlorine, bromine, or represents in each case optionally fluorine-, chlorine- and/or bromine-substituted methyl, ethyl, n- or i-propyl, n-, i-, s- or t-butyl, cyclopropyl, cyclobutyl, cyclopentyl, cyclohexyl or phenyl.
X¹ preferably represents nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
X² preferably represents hydrogen, nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
X³ preferably represents hydrogen, nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
R¹⁶ preferably represents hydrogen, methyl, ethyl, n- or i-propyl.
R¹⁷ preferably represents hydrogen, methyl, ethyl, n- or i-propyl.
R¹⁸ preferably represents hydrogen, in each case optionally cyano-, fluorine-, chlorine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino, or in each case optionally cyano-, fluorine-, chlorine-, bromine-, methyl-, ethyl-, n- or i-propyl-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino or cyclohexylamino.
R¹⁹ preferably represents hydrogen, in each case optionally cyano-, hydroxyl-, fluorine-, chlorine-, methoxy-, ethoxy-, n- or i-propoxy-substituted methyl, ethyl, n- or i-propyl, n-, i- or s-butyl, in each case optionally cyano-, fluorine-, chlorine- or bromine-substituted propenyl, butenyl, propynyl or butynyl, or in each case optionally cyano-, fluorine-, chlorine-, bromine-, methyl-, ethyl-, n- or i-propyl-substituted cyclopropyl, cyclobutyl, cyclopentyl or cyclohexyl.
R²⁰ preferably represents hydrogen, represents in each case optionally cyano-, hydroxyl-, fluorine-, chlorine-, methoxy-, ethoxy-, n- or i-propoxy-substituted methyl, ethyl, n- or i-propyl, n-, i- or s-butyl, in each case optionally cyano-, fluorine-, chlorine- or bromine-substituted propenyl, butenyl, propynyl or butynyl, in each case optionally cyano-, fluorine-, chlorine-, bromine-, methyl-, ethyl-, n- or i-propyl-substituted cyclopropyl, cyclobutyl, cyclopentyl or cyclohexyl, or optionally nitro-, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenyl, or together with R¹⁶ represents in each case optionally methyl- or ethyl-substituted butane-1,4-diyl (trimethylene), pentane-1,5-diyl, 1-oxa-butane-1,4-diyl or 3-oxa-pentane-1,5-diyl.
X⁴ preferably represents nitro, cyano, carboxyl, carbamoyl, formyl, sulfamoyl, hydroxyl, amino, fluorine, chlorine, bromine, methyl, ethyl, n- or i-propyl, n-, i-, s- or t-butyl, trifluoromethyl, methoxy, ethoxy, n- or i-propoxy, difluoromethoxy or trifluoromethoxy.
X⁵ preferably represents nitro, cyano, carboxyl, carbamoyl, formyl, sulfamoyl, hydroxyl, amino, fluorine, chlorine, bromine, methyl, ethyl, n- or i-propyl, n-, i-, s- or t-butyl, trifluoromethyl, methoxy, ethoxy, n- or i-propoxy, difluoromethoxy or trifluoromethoxy.

Examples of compounds of the formula (Ha) which are very particularly preferred as herbicide safeners according to the invention are listed in Table 2 below.

TABLE 2
Examples of the compounds of the formula (IIa)

| | |
|---|---|
| | (IIa) |
| 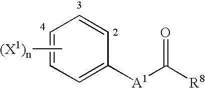 | |

| Example No. | (Positions) (X¹)ₙ | A¹ | R⁸ |
|---|---|---|---|
| IIa-1 | (2) Cl, (4) Cl | 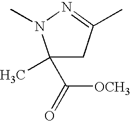 | OCH₃ |
| IIa-2 | (2) Cl, (4) Cl | 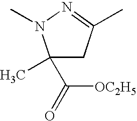 | OCH₃ |
| IIa-3 | (2) Cl, (4) Cl | 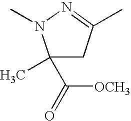 | OC₂H₅ |
| IIa-4 | (2) Cl, (4) Cl | 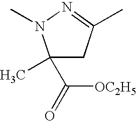 | OC₂H₅ |
| IIa-5 | (2) Cl | 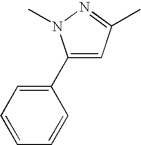 | OCH₃ |
| IIa-6 | (2) Cl, (4) Cl | 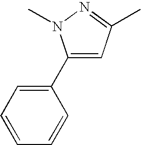 | OCH₃ |
| IIa-7 | (2) F | 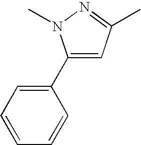 | OCH₃ |
| IIa-8 | (2) F | 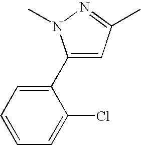 | OCH₃ |
| IIa-9 | (2) Cl, (4) Cl | 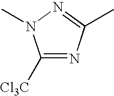 | OC₂H₅ |
| IIa-10 | (2) Cl, (4) CF₃ | 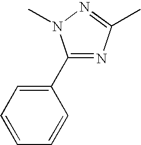 | OCH₃ |
| IIa-11 | (2) Cl | 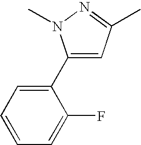 | OCH₃ |
| IIa-12 | — | 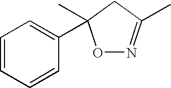 | OC₂H₅ |
| IIa-13 | (2) Cl, (4) Cl | 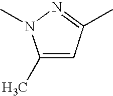 | OC₂H₅ |
| IIa-14 | (2) Cl, (4) Cl | 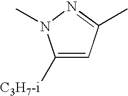 | OC₂H₅ |
| IIa-15 | (2) Cl, (4) Cl | 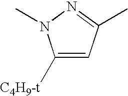 | OC₂H₅ |
| IIa-16 | (2) Cl, (4) Cl | 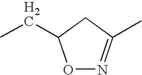 | OC₂H₅ |
| IIa-17 | (2) Cl, (4) Cl | 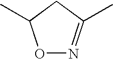 | OC₂H₅ |
| IIa-18 | — | 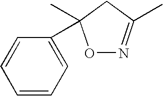 | OH |

Examples of compounds of the formula (IIb) which are very particularly preferred as herbicide safeners according to the invention are listed in Table 3 below.

TABLE 3

| | |
|---|---|
| | (IIb) |
| 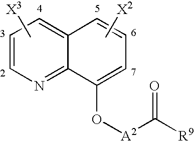 | |

Examples of compounds of the formula (IIb)

| Example | (Position) | (Position) | | |
|---|---|---|---|---|
| No. | X² | X³ | A² | R⁹ |
| IIb-1 | (5) | — | CH₂ | OH |
| | Cl | | | |
| IIb-2 | (5) | — | CH₂ | OCH₃ |
| | Cl | | | |
| IIb-3 | (5) | — | CH₂ | OC₂H₅ |
| | Cl | | | |
| IIb-4 | (5) | — | CH₂ | OC₃H₇-n |
| | Cl | | | |
| IIb-5 | (5) | — | CH₂ | OC₃H₇-i |
| | Cl | | | |
| IIb-6 | (5) | — | CH₂ | OC₄H₉-n |
| | Cl | | | |
| IIb-7 | (5) | — | CH₂ | OCH(CH₃)C₅H₁₁-n |
| | Cl | | | |
| IIb-8 | (5) | (2) | CH₂ | OH |
| | Cl | F | | |
| IIb-9 | (5) | (2) | CH₂ | OH |
| | Cl | Cl | | |
| IIb-10 | (5) | — | CH₂ | OCH₂CH═CH₂ |
| | Cl | | | |
| IIb-11 | (5) | — | CH₂ | OC₄H₉-i |
| | Cl | | | |
| IIb-12 | (5) Cl | — | CH₂ | 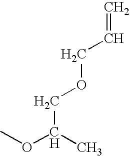 |
| IIb-13 | (5) Cl | — | 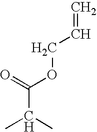 | OCH₂CH═CH₂ |
| IIb-14 | (5) Cl | — | 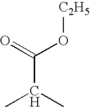 | OC₂H₅ |
| IIb-15 | (5) Cl | — | 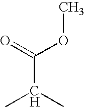 | OCH₃ |

Examples of the compounds (IIc) which are very particularly preferred as herbicide safeners according to the invention are listed in Table 4 below.

TABLE 4

| | |
|---|---|
| | (IIc) |
| 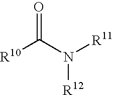 | |

Examples of the compounds of the formula (IIc)

| Example No. | R¹⁰ | N(R¹¹, R¹²) |
|---|---|---|
| IIc-1 | CHCl₂ | N(CH₂CH═CH₂)₂ |
| IIc-2 | CHCl₂ | 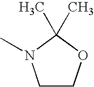 |
| IIc-3 | CHCl₂ | 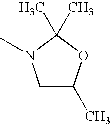 |
| IIc-4 | CHCl₂ | 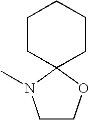 |
| IIc-5 | CHCl₂ | 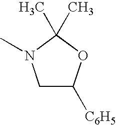 |
| IIc-6 | CHCl₂ | 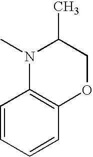 |
| IIc-7 | CHCl₂ | 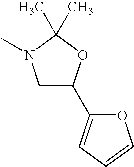 |

Examples of the compounds of the formula (IId) which are very particularly preferred as herbicide safeners according to the invention are listed in Table 5 below.

TABLE 5

| | |
|---|---|
| | (IId) |
| 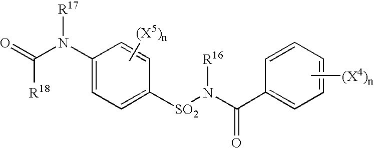 | |

Examples of the compounds of the formula (IId)

| | | | | (Positions) | (Positions) |
|---|---|---|---|---|---|
| Example No. | R¹⁶ | R¹⁷ | R¹⁸ | (X⁴)ₙ | (X⁵)ₙ |
| IId-1 | H | H | CH₃ | (2) OCH₃ | — |
| IId-2 | H | H | C₂H₅ | (2) OCH₃ | — |
| IId-3 | H | H | C₃H₇-n | (2) OCH₃ | — |
| IId-4 | H | H | C₃H₇-i | (2) OCH₃ | — |
| IId-5 | H | H | 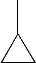 | (2) OCH₃ | — |
| IId-6 | H | H | CH₃ | (2) OCH₃ | — |
| | | | | (5) CH₃ | |
| IId-7 | H | H | C₂H₅ | (2) OCH₃ | — |
| | | | | (5) CH₃ | |
| IId-8 | H | H | C₃H₇-n | (2) OCH₃ | — |
| | | | | (5) CH₃ | |
| IId-9 | H | H | C₃H₇-i | (2) OCH₃ | — |
| | | | | (5) CH₃ | |
| IId-10 | H | H | 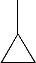 | (2) OCH₃(5) CH₃ | — |
| IId-11 | H | H | OCH₃ | (2) OCH₃ | — |
| | | | | (5) CH₃ | |
| IId-12 | H | H | OC₂H₅ | (2) OCH₃ | — |
| | | | | (5) CH₃ | |
| IId-13 | H | H | OC₃H₇-i | (2) OCH₃ | — |
| | | | | (5) CH₃ | |
| IId-14 | H | H | SCH₃ | (2) OCH₃ | — |
| | | | | (5) CH₃ | |
| IId-15 | H | H | SC₂H₅ | (2) OCH₃ | — |
| | | | | (5) CH₃ | |
| IId-16 | H | H | SC₃H₇-i | (2) OCH₃ | — |
| | | | | (5) CH₃ | |
| IId-17 | H | H | NHCH₃ | (2) OCH₃ | — |
| | | | | (5) CH₃ | |
| IId-18 | H | H | NHC₂H₅ | (2) OCH₃ | — |
| | | | | (5) CH₃ | |
| IId-19 | H | H | NHC₃H₇-i | (2) OCH₃ | — |
| | | | | (5) CH₃ | |
| IId-20 | H | H | 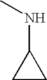 | (2) OCH₃(5) CH₃ | — |
| IId-21 | H | H | NHCH₃ | (2) OCH₃ | — |
| IId-22 | H | H | NHC₃H₇-i | (2) OCH₃ | — |
| IId-23 | H | H | N(CH₃)₂ | (2) OCH₃ | — |
| IId-24 | H | H | N(CH₃)₂ | (3) CH₃ | — |
| | | | | (4) CH₃ | |
| IId-25 | H | H | CH₂OCH₃ | (2) OCH₃ | — |
| IId-26 | H | H | CH₂OCH₃ | (2) OCH₃ | — |
| | | | | (5) CH₃ | |

Examples of the compounds of the formula (IIe) which are very particularly preferred as herbicide safeners according to the invention are listed in Table 6 below.

TABLE 6

| | |
|---|---|
| | (IIe) |
| 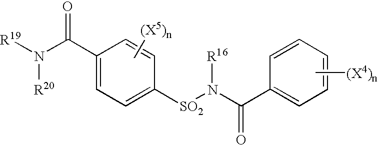 | |

Examples of the compounds of the formula (IIe)

| | | | | (Positions) | (Positions) |
|---|---|---|---|---|---|
| Example No. | R¹⁶ | R¹⁹ | R²⁰ | (X⁴)ₙ | (X⁵)ₙ |
| IIe-1 | H | H | CH₃ | (2) OCH₃ | — |
| IIe-2 | H | H | C₂H₅ | (2) OCH₃ | — |
| IIe-3 | H | H | C₃H₇-n | (2) OCH₃ | — |
| IIe-4 | H | H | C₃H₇-i | (2) OCH₃ | — |
| IIe-5 | H | H | 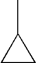 | (2) OCH₃ | — |
| IIe-6 | H | CH₃ | CH₃ | (2) OCH₃ | — |
| IIe-7 | H | H | CH₃ | (2) OCH₃ | — |
| | | | | (5) CH₃ | |
| IIe-8 | H | H | C₂H₅ | (2) OCH₃ | — |
| | | | | (5) CH₃ | |
| IIe-9 | H | H | C₃H₇-n | (2) OCH₃ | — |
| | | | | (5) CH₃ | |
| IIe-10 | H | H | C₃H₇-i | (2) OCH₃ | — |
| | | | | (5) CH₃ | |
| IIe-11 | H | H | 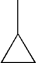 | (2) OCH₃(5) CH₃ | — |
| IIe-12 | H | CH₃ | CH₃ | (2) OCH₃ | — |
| | | | | (5) CH₃ | |

Most preference is given as the crop plant compatibility-improving compound [component (b)] to cloquinbocet-mexyl, fenchlorazole-ethyl, isoxadifen-ethyl, mefenpyr-diethyl, furilazole, fenclorim, cumyluron, dymron, dimepiperate and the compounds Ile-5, and Ile-11, with eloquinbocet-mexyl and mefenpyr-diethyl being particularly emphasized.

The compounds of the general formula (IIa) to be used as safeners according to the invention are known and/or can be prepared by processes known per se (cf. WO-A-91/07874, WO-A-95/07897).

The compounds of the general formula (IIb) to be used as safeners according to the invention are known and/or can be prepared by processes known per se (cf. EP-A-191736).

The compounds of the general formula (tic) to be used as safeners according to the invention are known and/or can be prepared by processes known per se (cf. DE-A-2218097, DE-A-2350547).

The compounds of the general formula (IId) to be used as safeners according to the invention are known and/or can be prepared by processes known per se (cf DE-A-19621522/U.S. Pat. No. 6,235,680).

The compounds of the general formula (IIe) to be used as safeners according to the invention are known and/or can be prepared by processes known per se (cf. WO-A-99/667951 U.S. Pat. No. 6,251,827).

Examples of the selectively herbicidal combinations according to the invention of in each case one active compound of the formula (I) and in each case one of the safeners defined above are listed in Table 7 below.

TABLE 7
Examples of combinations according to the invention

| Active compound of the formula (I) | Safener |
|---|---|
| I-1 | cloquintocet-mexyl |
| I-1 | fenchlorazole-ethyl |
| I-1 | isoxadifen-ethyl |
| I-1 | mefenpyr-diethyl |
| I-1 | furilazole |
| I-1 | fenclorim |
| I-1 | cumyluron |
| I-1 | daimuron/dymron |
| I-1 | dimepiperate |
| I-1 | Ile-11 |
| I-1 | Ile-5 |
| I-2 | cloquintocet-mexyl |
| I-2 | fenchlorazole-ethyl |
| I-2 | isoxadifen-ethyl |
| I-2 | mefenpyr-diethyl |
| I-2 | furilazole |
| I-2 | fenclorim |
| I-2 | cumyluron |
| I-2 | daimuron/dymron |
| I-2 | dimepiperate |
| I-2 | Ile-11 |
| I-2 | Ile-5 |
| I-3 | cloquintocet-mexyl |
| I-3 | fenchlorazole-ethyl |
| I-3 | isoxadifen-ethyl |
| I-3 | mefenpyr-diethyl |
| I-3 | furilazole |
| I-3 | fenclorim |
| I-3 | cumyluron |
| I-3 | daimuron/dymron |
| I-3 | dimepiperate |
| I-3 | Ile-5 |
| I-3 | Ile-11 |
| I-4 | cloquintocet-mexyl |
| I-4 | fenchlorazole-ethyl |
| I-4 | isoxadifen-ethyl |
| I-4 | mefenpyr-diethyl |
| I-4 | furilazole |
| I-4 | fenclorim |
| I-4 | cumyluron |
| I-4 | daimuron/dymron |
| I-4 | dimepiperate |
| I-4 | Ile-11 |
| I-4 | Ile-5 |
| I-5 | cloquintocet-mexyl |
| I-5 | fenchlorazole-ethyl |
| I-5 | isoxadifen-ethyl |
| I-5 | mefenpyr-diethyl |
| I-5 | furilazole |
| I-5 | fenclorim |
| I-5 | cumyluron |
| I-5 | daimuron/dymron |
| I-5 | dimepiperate |
| I-5 | Ile-5 |
| I-5 | Ile-11 |
| I-6 | cloquintocet-mexyl |
| I-6 | fenchlorazole-ethyl |
| I-6 | isoxadifen-ethyl |
| I-6 | mefenpyr-diethyl |
| I-6 | furilazole |
| I-6 | fenclorim |
| I-6 | cumyluron |
| I-6 | daimuron/dymron |
| I-6 | dimepiperate |
| I-6 | Ile-5 |
| I-6 | Ile-11 |

Surprisingly, it has now been found that the above-defined active compound combinations of substituted aryl ketones of the general formula (I) and safeners (antidotes) of group (b) listed above, whilst being tolerated very well by crop plants, have particularly high herbicidal activity and can be used in various crops, in particular in cereal (especially wheat), but also in soybeans, potatoes, corn and rice, for the selective control of weeds.

Here, it has to be considered to be surprising that, from a large number of known safeners or antidotes which are capable of antagonizing the damaging effect of a herbicide on the crop plants, it is in particular the abovementioned compounds of group (b) which neutralize the damaging effect of substituted aryl ketones on the crop plants virtually completely without negatively affecting the herbicidal activity with respect to the weeds.

Emphasis is given here to the particularly advantageous effect of the particularly and most preferred combination partners from group (b), in particular in respect of sparing cereal plants, such as, for example, wheat, barley and rye, but also corn and rice, as crop plants.

The active compound combinations according to the invention can be used, for example, in connection with the following plants:

Dicotyledonous weeds of the genera: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

Dicotyledonous crops of the genera: Gossypium, Glycine, Beta, Daucus, Phaseolus, Pisum, Solanum, Linum, Ipomoea, Vicia, Nicotiana, Lycopersicon, Arachis, Brassica, Lactuca, Cucumis, Cuburbita, Helianthus.

Monocotyledonous weeds of the genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecunis, Apera.

Monocotyledonous crops of the genera: Oryza, Zea, Triticum, Hordeum, Avena, Secale, Sorghum, Panicum, Saccharum, Ananas, Asparagus, Allium.

However, the use of the active compound combinations according to the invention is in no way restricted to these genera, but also extends in the same manner to other plants.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and recombinant methods or by combinations of these methods, including the transgenic plants and inclusive of the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, and also roots, tubers and rhizomes. The plant parts also include harvested material, and vegetative and generative propagation material, for example cuttings, tubers, rhizomes, offshoots and seeds.

The treatment according to the invention of the plants and plant parts with the active compounds is carried out directly or by allowing the compounds to act on the surroundings, environment or storage space by the customary treatment methods, for example by immersion, spraying, evaporation, fogging, scattering, painting on, and, in the case of propagation material, in particular in the case of seeds, also by applying one or more coats.

The advantageous effect of the crop plant compatibility of the active compound combinations according to the invention is particularly highly pronounced at certain concentration ratios. However, the weight ratios of the active compounds in the active compound concentrations can be varied within relatively wide ranges. In general, 0.001 to 1000 parts by weight, preferably 0.01 to 100 parts by weight, and particularly preferably 0.05 to 10 parts by weight and most preferably 0.07 to 1.5 parts by weight of one of the compounds which improve crop plant compatibility mentioned under (b) above (antidotes/safeners) are present per part by weight of active compound of the formula (I) or its salts.

The active compounds or active compound combinations can be converted into the customary formulations, such as solutions, emulsions, wettable powders, suspensions, powders, dusting agents, pastes, soluble powders, granules, suspoemulsion concentrates, natural and synthetic materials impregnated with active compound, and microencapsulations in polymeric substances.

These formulations are produced in a known manner, for example by mixing the active compounds with extenders, that is liquid solvents and/or solid carriers, optionally with the use of surfactants, that is emulsifiers and/or dispersants and/or foam-formers.

If the extender used is water, it is also possible to use, for example, organic solvents as auxiliary solvents. Suitable liquid solvents are essentially: aromatics, such as xylene, toluene or alkylnaphthalenes, chlorinated aromatics and chlorinated aliphatic hydrocarbons, such as chlorobenzenes, chloroethylenes or methylene chloride, aliphatic hydrocarbons, such as cyclohexane or paraffins, for example petroleum fractions, mineral and vegetable oils, alcohols, such as butanol or glycol, and also their ethers and esters, ketones, such as acetone, methyl ethyl ketone, methyl isobutyl ketone or cyclohexanone, strongly polar solvents, such as dimethylformamide and dimethyl sulfoxide, and also water.

Suitable solid carriers are:

for example ammonium salts and ground natural minerals, such as kaolins, clays, talc, chalk, quartz, attapulgite, montmorillonite or diatomaceous earth, and ground synthetic minerals, such as finely divided silica, alumina and silicates, suitable solid carriers for granules are: for example crushed and fractionated natural rocks such as calcite, marble, pumice, sepiolite and dolomite, and also synthetic granules of inorganic and organic meals, and granules of organic material such as sawdust, coconut shells, corn cobs and tobacco stalks; suitable emulsifiers and/or foam-formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and protein hydrolyzates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise from 0.1 to 95 percent by weight of active compounds including the safeners, preferably from 0.5 to 90%.

The active compound combinations according to the invention are generally used in the form of finished formulations. However, the active compounds contained in the active compound combinations can also be mixed in individual formulations when used, i.e. in the form of tank mixes.

The novel active compound combinations, as such or in their formulations, can furthermore be used as a mixture with other known herbicides, finished formulations or tank mixes again being possible. A mixture with other known active compounds, such as fungicides, insecticides, acaricides, nematicides, bird repellents, growth factors, plant nutrients and agents which improve soil structure, is also possible. For certain intended uses, in particular in the post-emergence method, it may fuithermore be advantageous to include, as further additives in the formulations, mineral or vegetable oils which are tolerated by plants (for example the commercial preparation “Rako Binol”), or ammonium salts such as, for example, ammonium sulfate or ammonium thiocyanate.

The novel active compound combinations can be used as such, in the form of their formulations or the use forms prepared therefrom by further dilution, such as ready-to-use solutions, suspensions, emulsions, powders, pastes and granules. They are used in the customary manner, for example by washing, spraying, atomizing, dusting or scattering.

The amounts of the active compound combinations according to the invention applied can be varied within a certain range; they depend, inter alia, on the weather and on soil factors. In general, the application rates are between 0.005 and 5 kg per ha, preferably between 0.01 and 2 kg per ha, particularly preferably between 0.05 and 1.0 kg per ha.

The active compound combinations according to the invention can be applied before and after emergence of the plants, that is to say by the pre-emergence and post-emergence method.

Depending on their properties, the safeners to be used according to the invention can be used for pre-treating the seed of the crop plant (seed dressing), or they can be introduced into the seed ferrules before sowing or applied together with the herbicide before or after emergence of the plants.

According to the invention, the dicarbonyl compound of the formula (I) and the crop plant compatibility-improving compound can also be applied separately, one soon after the other. The compatibility improvements according to the invention are achieved even when the safener compound is applied shortly before or after the treatment with the dicarbonyl compound of the formula (I). In this context, soon means preferably a week and particularly preferably one to two days.

Accordingly, the invention also comprises a method for controlling unwanted vegetation, characterized in that a dicarbonyl compound of the formula (I) and the crop plant compatibility-improving compound are allowed to act separately onto the plants or their habitat, one compound soon after the other.

As already mentioned above, it is possible to treat all plants and their parts in accordance with the invention. In a preferred embodiment, wild plant species or plant varieties and plant cultivars which have been obtained by traditional biological breeding methods, such as hybridization or protoplast fusion, and the parts of these varieties and cultivars are treated. In a further preferred embodiment, transgenic plants and plant cultivars which have been obtained by recombinant methods, if appropriate in combination with conventional methods (genetically modified organisms), and their parts are treated. The term “parts” or “parts of plants” or “plant parts” has been explained above.

Plants which are treated particularly preferably in accordance with the invention are those of the plant cultivars which are in each case commercially available or in use. Plant cultivars are understood as meaning plants with particular traits which have been bred either by conventional breeding, by mutagenesis or by recombinant DNA techniques. They may take the form of cultivars, biotypes and genotypes.

Depending on the plant species or plant cultivars, their location and growth conditions (soils, climate, vegetation period, nutrition), the treatment according to the invention may also result in superadditive (“synergistic”) effects. Thus, for example, reduced application rates and/or a widened activity spectrum and/or an increase in the activity of the substances and compositions which can be used in accordance with the invention, even in combination with other agrochemically active compounds, better crop plant growth, increased tolerance of the crop plants to high or low temperatures, increased tolerance of the crop plants to drought or to salinity in the water or soil, increased flowering performance, facilitated harvesting, accelerated maturation, higher yields, higher quality and/or better nutritional value of the harvested products, better storage characteristics and/or processibility of the harvested products are possible which exceed the effects which were actually to be expected.

The preferred transgenic plants or plant cultivars (those obtained by recombinant methods) to be treated in accordance with the invention include all those plants which, owing to the process of recombinant modification, were given genetic material which confers particular, advantageous, valuable traits to these plants. Examples of such properties are better plant growth, increased tolerance to high or low temperatures, increased tolerance to drought or to salinity in the water or soil, increased flowering performance, facilitated harvesting, accelerated maturation, higher yields, higher quality and/or higher nutritional value of the harvested products, better storage characteristics and/or processibility of the harvested products. Further examples of such traits, examples which must be mentioned especially, are better defense of the plants against animal and microbial pests, such as against insects, mites, phytopathogenic fungi, bacteria and/or viruses and an increased tolerance of the plants to certain herbicidal active compounds. Examples of transgenic plants which may be mentioned are the important crop plants, such as cereals (wheat, rice), corn, soybeans, potato, cotton, oilseed rape, and fruit plants (with the fruits apples, pears, citrus fruits and grapes), with particular emphasis on corn, soybeans, potato, cotton and oilseed rape. Traits which are especially emphasized are the increased defense of the plants against insects, owing to toxins being formed in the plants, in particular toxins which are generated in the plants by the genetic material of Bacillus thuringiensis (for example by the genes CryIA(a), CryIA(b), CryIA(c), CryIIA, CryIIIA, CryIIIB2, Cry9c, Cry2Ab, Cry3Bb and CryIF and their combinations; hereinbelow “Bt plants”). Other traits which are particularly emphasized are the increased defense of plants against fungi, bacteria and viruses by the systemic acquired resistance (SAR), systemin, phytoalexins, elicitors and resistance genes and correspondingly expressed proteins and toxins. Other traits which are especially emphasized are the increased tolerance of the plants to certain herbicidal active compounds, for example imidazolinones, sulfonylureas, glyphosate or phosphinothricin (for example “PAT” gene). The genes which confer the desired traits in each case may also be present in the tnansgenic plants in combination with one another. Examples of “Bt plants” which may be mentioned are corn cultivars, cotton cultivars, soybean cultivars and potato cultivars which are commercially available under the trade names YIELD GARD® (for example corn, cotton, soybeans), KnockOut® (for example corn), StarLink®0 (for example corn), Bollgard® (cotton), Nucotn® (cotton) and NewLeaf® (potato). Examples of herbicide-tolerant plants which may be mentioned are corn cultivars, cotton cultivars and soybean cultivars which are commercially available under the trade names Roundup Ready® (tolerance to glyphosate, for example corn, cotton, soybean), Liberty Link® (tolerance to phosphinothricin, for example oilseed rape), IMIg (tolerance to imidazolinones) and STS® (tolerance to sulfonylureas, for example corn). Herbicide-resistant plants (plants bred in a conventional manner for herbicide tolerance) which may be mentioned include also the varieties commercially available under the name Clearfield® (for example corn). Naturally, these statements also apply to plant cultivars having these genetic traits or genetic traits still to be developed, which plant cultivars will be developed and/or marketed in the future.

According to the invention, the plants listed can be treated particularly advantageously with the compounds of the general formula I or the active compound mixtures according to the invention where, in addition to the effective control of the weed plants, the abovementioned synergistic effects with the transgenic plants or plant cultivars occur. The preferred ranges stated above for the active compounds and mixtures also apply to the treatment of these plants. Particular emphasis may be given to the treatment of plants with the compounds or mixtures specifically mentioned in the present text.

### USE EXAMPLES

Herbicidal Post-Emergence Action

Seeds of monocotyledonous and dicotyledonous weed and crop plants are placed into sandy loam in wood fiber pots or in plastic pots, covered with soil and cultivated in a greenhouse, including during the vegetation period outdoors outside of the greenhouse, under good growth conditions. Two-three weeks after sowing, the test plants are treated at the one- to three-leaf stage. The test plants, formulated as wettable powders (WP) or emulsifiable concentrates (EC) are, in various dosages with a water application rate of 300 l/ha (converted), with added wetting agent (0.2 to 0.3%) sprayed onto the plants and the surface of the soil. Three to four weeks after the treatment of the test plants, the effect of the preparations is rated visually in comparison to untreated controls (herbicidal effect in percent (%): 100% effect=plants have died, 0% effect=like control plants).

Use of Safeners

If it is additionally to be tested as to whether safeners can improve the plant compatibility of test substances in the case of crop plants, the following options are used for applying the safener:

seeds of the crop plants are, before sowing, dressed with the safener substance (the amount of safener is stated in percent, based on the weight of the seed)

before the application of the test substances, the crop plants are sprayed with the safener at a certain application rate per hectare (usually 1 day before the application of the test substances).

the safener is applied together with the test substance as a tank mix (the amount of safener is stated in g/ha or as a ratio, based on the herbicide).

By comparing the effect of the test substances on crop plants without or with safener treatment, it is possible to assess the effect of the safener substance.

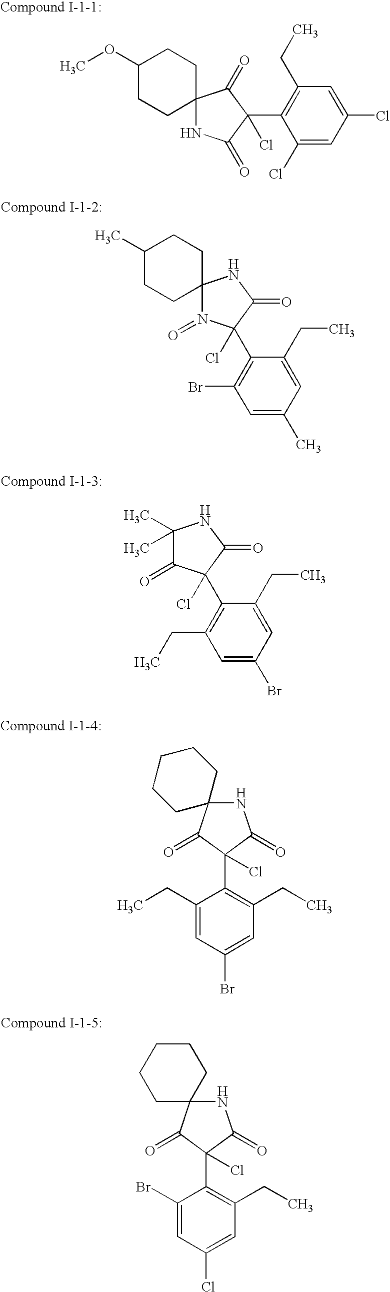

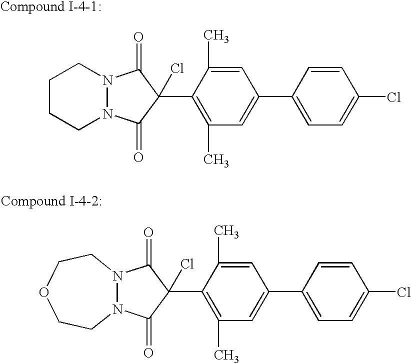

### Example 1

Outdoor trial/Post-emergence

Tank mix

Ratio mefenpyr-diethyl:compound of the formula (I)=2:1

| | Herbicide | | | | |
|---|---|---|---|---|---|
| | application | Summer | Winter | Summer | Winter |
| Compound | rate | barley | barley | wheat | wheat |
| Comp. No. I-1-1 | 0.120 kg/ha | 40 | 30 | 15 | 20 |
| Comp. No. I-1-1 + | 0.120 kg/ha | 0 | 0 | 0 | 0 |
| mefenpyr | | | | | |
| Comp. No. I-1-2 | 0.120 kg/ha | 15 | 0 | 0 | 0 |
| Comp. No. I-1-2 + | 0.120 kg/ha | 0 | 0 | 0 | 0 |
| mefenpyr | | | | | |

### Example 2

Greenhouse trial/Post-emergence

One day before the application of the compounds of the formula (I), the crop plants are treated with the safener (application rate 100 g/ha).

| | Herbicide | | |
|---|---|---|---|
| Compound | application rate | Summer barley | Summer wheat |
| Comp. No. I-1-4 | 0.100 kg/ha | 10 | 10 |
| Comp. No. I-1-4 + | 0.100 kg/ha | 0 | 10 |
| mefenpyr | | | |
| Comp. No. I-1-5 | 0.100 kg/ha | 92 | 65 |
| | 0.050 kg/ha | 50 | 60 |
| | 0.025 kg/ha | 20 | 30 |
| Comp. No. I-1-5 + | 0.100 kg/ha | 40 | 25 |
| mefenpyr | 0.050 kg/ha | 20 | 10 |
| | 0.025 kg/ha | 10 | 5 |
| Comp. No. I-4-1 | 0.100 kg/ha | 80 | 60 |
| | 0.050 kg/ha | 80 | 60 |
| | 0.025 kg/ha | 20 | 20 |
| Comp. No. I-4-1 + | 0.100 kg/ha | 20 | 15 |
| mefenpyr | 0.050 kg/ha | 0 | 5 |
| | 0.025 kg/ha | 0 | 0 |
| Comp. No. I-4-2 | 0.100 kg/ha | 97 | 97 |
| | 0.050 kg/ha | 95 | 97 |
| | 0.025 kg/ha | 40 | 60 |
| Comp. No. I-4-2 + | 0.100 kg/ha | 20 | 80 |
| mefenpyr | 0.050 kg/ha | 10 | 40 |
| | 0.025 kg/ha | 0 | 20 |

### Example 3

Greenhouse Trial/Post-Emergence

Corn of the Cultivar Lorenzo

Addition of Safener:
a) Before sowing, seeds of the crop plants are dressed with the compound of the formula (IIe-5) (0.5% of safener, based on the weight of the seeds).
b) One day before the application of the compounds of the formula (I), the crop plants are treated with the compound of the formula (IIe-5) (application rate 100 g/ha).
c) One day before the application of the compounds of the formula (I), the crop plants are treated with isoxadifen (application rate 100 g/ha)

For the spray treatment, the herbicide was formulated as WP20 and the safener as WP10.

| Compound | Herbicide application rate | Corn |
|---|---|---|
| Compound I-1-1 | 0.050 kg/ha | 100 |
| | 0.025 kg/ha | 100 |
| | 0.013 kg/ha | 99 |
| Compound I-1-1 + safener | 0.050 kg/ha | 100 |
| added by method a) | 0.025 kg/ha | 95 |
| | 0.013 kg/ha | 65 |
| Compound I-1-1 + safener | 0.050 kg/ha | 100 |
| added by method b) | 0.025 kg/ha | 100 |
| | 0.013 kg/ha | 90 |
| Compound I-1-1 + safener | 0.050 kg/ha | 100 |
| added by method c) | 0.025 kg/ha | 100 |
| | 0.013 kg/ha | 100 |
| Compound I-1-3 | 0.050 kg/ha | 85 |
| | 0.025 kg/ha | 0 |
| | 0.013 kg/ha | 0 |
| Compound I-1-3 + safener | 0.050 kg/ha | 5 |
| added by method a) | 0.025 kg/ha | 0 |
| | 0.013 kg/ha | 0 |
| Compound I-1-3 + safener | 0.050 kg/ha | 10 |
| added by method b) | 0.025 kg/ha | 0 |
| | 0.013 kg/ha | 0 |
| Compound I-1-3 + safener | 0.050 kg/ha | 5 |
| added by method c) | 0.025 kg/ha | 0 |
| | 0.013 kg/ha | 0 |

What is claimed is:

1-9. (canceled)

10. A composition comprising an active compound combination comprising
(a) one or more substituted cyclic dicarbonyl compounds of formula (I) 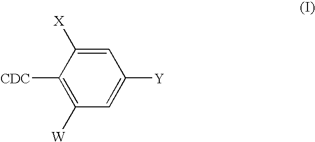
or isomeric forms thereof,
in which
W represents hydrogen, halogen, alkyl, alkenyl, alkynyl, alkoxy, alkenyloxy, haloalkyl, haloalkoxy, haloalkenyloxy, nitro, or cyano,
X represents halogen, alkyl, alkenyl, alkynyl, alkoxy, alkenyloxy, alkylthio, alkylsulfinyl, alkylsulfonyl, haloalkyl, haloalkoxy, haloalkenyloxy, nitro, or cyano,
Y represents hydrogen, halogen, alkyl, haloalkyl, haloalkoxy, nitro, or cyano, or represents optionally substituted phenyl or hetaryl, and
CDC represents one of the groups 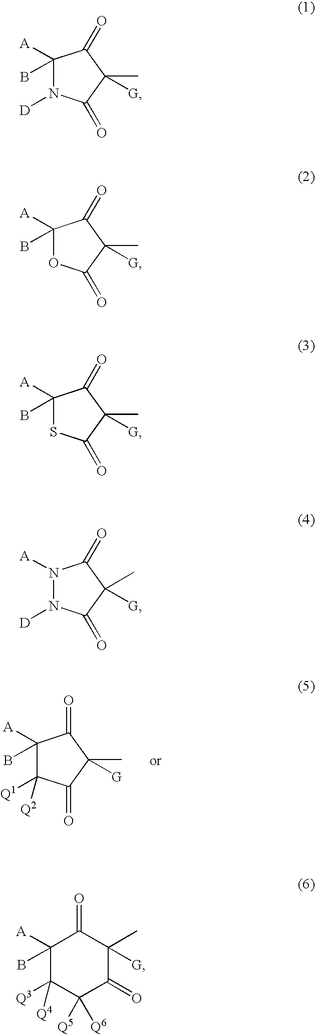
in which
A represents hydrogen; optionally halogen-substituted alkyl, alkenyl, alkoxyalkyl, or alkylthioalkyl; optionally substituted saturated or unsaturated cycloalkyl in which one or more ring atoms are optionally replaced by a heteroatom; or optionally halogen-, alkyl-, haloalkyl-, alkoxy-, haloalkoxy-, cyano-, or nitro-substituted aryl, arylalkyl, or hetaryl,
B represents hydrogen, alkyl or alkoxyalkyl, or
A and B together with the carbon atom to which they are attached represent an unsubstituted or substituted cycle that is saturated or unsaturated and optionally contains one or more heteroatoms,
D represents hydrogen or an optionally substituted radical from the group consisting of alkyl, alkenyl, alkynyl, alkoxyalkyl, saturated or unsaturated cycloalkyl in which one or more ring members are optionally replaced by heteroatoms, arylalkyl, aryl, hetarylalkyl, or hetaryl, or
A and D together with the atoms to which they attached represent a cycle that is saturated or unsaturated and optionally contains one or more heteroatoms and is unsubstituted or substituted in the A,D-moiety,
Q¹ represents hydrogen or alkyl, or
A and Q¹ together represent alkanediyl or alkenediyl that are optionally substituted by hydroxyl; or optionally substituted alkyl, alkoxy, alkylthio, cycloalkyl, benzyloxy, or aryl,
Q², Q⁴, Q⁵, and Q⁶ independently of one another represent hydrogen or alkyl,
Q³ represents hydrogen, alkyl, alkoxyalkyl, or alkylthioalkyl; optionally substituted cycloalkyl in which one methylene group is optionally replaced by oxygen or sulfur; or optionally substituted phenyl, or
Q³ and Q⁴ together with the carbon atom to which they are attached represent an unsubstituted or substituted cycle that is saturated or unsaturated and optionally contains a heteroatom, and
G represents halogen or nitro,
and
(b) one or more compounds that improves crop plant compatibility selected from the group consisting of 4-dichloroacetyl-1-oxa-4-azaspiro[4.5]-decane (AD-67, MON-4660), 1-dichloroacetylhexahydro-3,3,8a-trimethylpyrrolo[1,2-a]-pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinolin-8-oxyacetate (cloquintocet-mexyl), 3-(2-chlorobenzyl)-1-(1-methyl-1-phenyl-ethyl)urea (cumyluron), α-(cyanomethoximino)phenylacetonitrile (cyometrinil), 2,4-dichlorophenoxyacetic acid (2,4-D), 4-(2,4-dichlorophenoxy)butyric acid (2,4-DB), 1-(1-methyl-1-phenylethyl)-3-(4-methylphenyl)-urea (daimuron, dymron), 3,6-dichloro-2-methoxybenzoic acid (dicamba), S-1-methyl-1-phenylethyl piperidine-1-thiocarboxylate (dimepiperate), 2,2-dichloro-N-(2-oxo-2-(2-propenylamino)ethyl)-N-(2-propenyl)acetamide (DKA-24), 2,2-dichloro-N,N-di-2-propenylacetamide (dichlormid), 4,6-dichloro-2-phenyl-pyrimidine (fenclorim), ethyl 1-(2,4-dichlorophenyl)-5-trichloromethyl-1H-1,2,4-triazole-3-carboxylate (fenchlorazole-ethyl), phenylmethyl 2-chloro-4-trifluoromethylthiazole-5-carboxylate (flurazole), 4-chloro-N-(1,3-dioxolan-2-ylmethoxy)-α-trifluoro-acetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl), 1-(ethoxycarbonyl)-ethyl 3,6-dichloro-2-methoxybenzoate (lactidichlor), (4-chloro-o-tolyloxy)acetic acid (MCPA), 2-(4-chloro-o-tolyloxy)propionic acid (mecoprop), diethyl 1-(2,4-dichloro-phenyl)-4,5-dihydro-5-methyl-1H-pyrazole-3,5-dicarboxylate (mefenpyr-diethyl), 2-dichloromethyl-2-methyl-1,3-dioxolane (MG-191), 2-propenyl-1-oxa-4-azaspiro[4.5]decane 4-carbodithioate (MG-838), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)-acetamide (PPG-1292), 3-dichloroacetyl-2,2-dimethyloxazolidine (R-28725), 3-dichloroacetyl-2,2,5-trimethyloxazolidine (R-29148), 4-(4-chloro-o-tolyl)-butyric acid, 4-(4-chlorophenoxy)butyric acid, diphenylmethoxyacetic acid, methyl diphenylmethoxyacetate, ethyl diphenylmethoxyacetate, methyl 1-(2-chlorophenyl)-5-phenyl-1H-pyrazole-3-carboxylate, ethyl 1-(2,4-dichloro-phenyl)-5-methyl-1H-pyrazole-3-carboxylate, ethyl 1-(2,4-dichlorophenyl)-5-isopropyl-1H-pyrazole-3-carboxylate, ethyl 1-(2,4-dichlorophenyl)-5-(1,1-dimethylethyl)-1H-pyrazole-3-carboxylate, ethyl 1-(2,4-dichlorophenyl)-5-phenyl-1H-pyrazole-3-carboxylate, ethyl 5-(2,4-dichlorobenzyl)-2-isoxazoline-3-carboxylate, ethyl 5-phenyl-2-isoxazoline-3-carboxylate, ethyl 5-(4-fluoro-phenyl)-5-phenyl-2-isoxazoline-3-carboxylate, 1,3-dimethylbut-1-yl 5-chloro-quinolin-8-oxyacetate, 4-allyloxybutyl 5-chloroquinolin-8-oxy-acetate, 1-allyl-oxy-prop-2-yl 5-chloroquinolin-8-oxy-acetate, methyl 5-chloroquinolin-8-oxyacetate, ethyl 5-chloroquinolin-8-oxy-acetate, allyl 5-chloroquinolin-8-oxyacetate, 2-oxoprop-1-yl 5-chloroquinolin-8-oxy-acetate, diethyl 5-chloro-quinolin-8-oxymalonate, diallyl 5-chloroquinolin-8-oxymalonate, diethyl 5-chloroquinolin-8-oxy-malonate, 4-carboxychroman-4-ylacetic acid (AC-304415), 4-chlorophenoxyacetic acid, 3,3′-dimethyl-4-methoxybenzo-phenone, 1-bromo-4-chloromethylsulfonyl-benzene, 1-[4-(N-2-methoxy-benzoylsulfamoyl)phenyl]-3-methyl-urea (also known as N-(2-methoxy-benzoyl)-4-[(methylaminocarbonyl)amino]-benzenesulfonamide), 1-[4-(N-2-methoxybenzoylsulfamoyl)-phenyl]-3,3-dimethyl-urea, 1-[4-(N-4,5-dimethyl-benzoylsulfamoyl)phenyl]-3-methylurea, 1-[4-(N-naphthylsulfamoyl)phenyl]-3,3-dimethylurea, N-(2-methoxy-5-methylbenzoyl)-4-(cyclopropylamino carbonyl)benzenesulfonamide, a compound having formula (IIa) 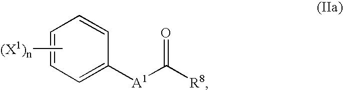
where
n represents a number between 0 and 5,
X¹ represents nitro, cyano, halogen, C₁-C₄-alkyl, C₁-C₄-haloalkyl, C₁-C₄-alkoxy, or C₁-C₄-haloalkoxy,
A¹ represents a divalent heterocyclic group 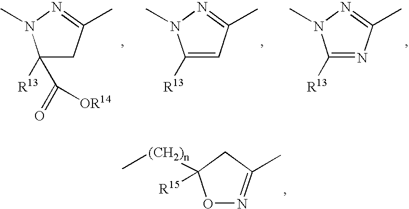
R⁸ represents hydroxyl, mercapto, amino, C₁-C₆-alkoxy, C₁-C₆-alkylthio, C₁-C₆-alkylamino, or di(C₁-C₄-alkyl)-amino,
R¹³ represents hydrogen, cyano, or halogen; or represents optionally fluorine-, chlorine-, and/or bromine-substituted C₁-C₄-alkyl, C₃-C₆-cycloalkyl, or phenyl,
R¹⁴ represents hydrogen, optionally hydroxyl-, cyano-, halogen-, or C₁-C₄-alkoxy-substituted C₁-C₆-alkyl, C₃-C₆-cycloalkyl, or tri(C₁-C₄-alkyl)-silyl, and
R¹⁵ represents hydrogen, cyano, or halogen; or represents optionally fluorine-, chlorine-, and/or bromine-substituted C₁-C₄-alkyl, C₃-C₆-cycloalkyl or phenyl,
a compound having formula (IIb) 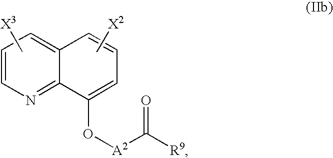
where
A² represents optionally C₁-C₄-alkyl- and/or C₁-C₄-alkoxy-carbonyl-substituted alkanediyl having 1 or 2 carbon atoms,
X² represents hydrogen, cyano, nitro, halogen, C₁-C₄-alkyl, C₁-C₄-haloalkyl, C₁-C₄-alkoxy, or C₁-C₄-haloalkoxy,
X³ represents hydrogen, cyano, nitro, halogen, C₁-C₄-alkyl, C₁-C₄-haloalkyl, C₁-C₄-alkoxy, or C₁-C₄-haloalkoxy, and
R⁹ represents hydroxyl, mercapto, amino, C₁-C₆-alkoxy, C₁-C₆-alkylthio, C₁-C₆-alkylamino, or di(C₁-C₄-alkyl)-amino,
a compound having formula (IIc) 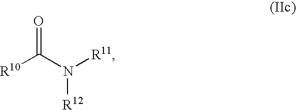
where
R¹⁰ represents optionally fluorine-, chlorine-, and/or bromine-substituted C₁-C₄-alkyl,
R¹¹ represents hydrogen; optionally fluorine-, chlorine-, and/or bromine-substituted C₁-C₆-alkyl, C₂-C₆-alkenyl, or C₂-C₆-alkynyl; C₁-C₄-alkoxy-C₁-C₄-alkyl, dioxolanyl-C₁-C₄-alkyl, furyl, furyl-C₁-C₄-alkyl, thienyl, thiazolyl, or piperidinyl; or optionally fluorine-, chlorine-, and/or bromine- or C₁-C₄-alkyl-substituted phenyl, and
R¹² represents hydrogen; optionally fluorine-, chlorine-, and/or bromine-substituted C₁-C₆-alkyl, C₂-C₆-alkenyl, or C₂-C₆-alkynyl; C₁-C₄-alkoxy-C₁-C₄-alkyl, dioxolanyl-C₁-C₄-alkyl, furyl, furyl-C₁-C₄-alkyl, thienyl, thiazolyl, or piperidinyl; or optionally fluorine-, chlorine-, and/or bromine- or C₁-C₄-alkyl-substituted phenyl; or R¹² together with R¹¹ represents C₃-C₆-alkanediyl or C₂-C₅-oxaalkanediyl, each of which is optionally substituted by C₁-C₄-alkyl, phenyl, furyl, a fused-on benzene ring, or by two substituents that together with the C atom to which they are attached form a 5- or 6-membered carbocycle,
a compound having formula (IId) 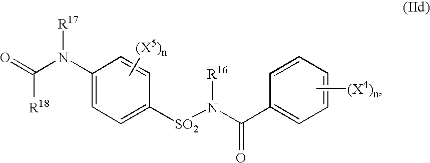
where
n represents a number between 0 and 5,
X⁴ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy, or C₁-C₄-haloalkoxy,
X⁵ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy, or C₁-C₄-haloalkoxy,
R¹⁶ represents hydrogen or C₁-C₄-alkyl,
R¹⁷ represents hydrogen or C₁-C₄-alkyl, and
R¹⁸ represents hydrogen; optionally cyano-, halogen-, or C₁-C₄-alkoxy-substituted C₁-C₆-alkyl, C₁-C₆-alkoxy, C₁-C₆-alkylthio, C₁-C₆-alkylamino, or di(C₁-C₄-alkyl)-amino; or optionally cyano-, halogen-, or C₁-C₄-alkyl-substituted C₃-C₆-cycloalkyl, C₃-C₆-cycloalkyloxy, C₃-C₆-cycloalkylthio, or C₃-C₆-cycloalkylamino, and
a compound having formula (IIe) 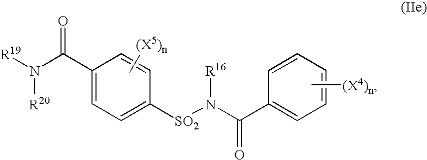
where
n represents a number between 0 and 5,
x⁴ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy, or C₁-C₄-haloalkoxy,
X⁵ represents nitro, cyano, carboxyl, carbamoyl, formyl, sulfamoyl, hydroxyl, amino, halogen, C₁-C₄-alkyl, C₁-C₄-haloalkyl, C₁-C₄-alkoxy, or C₁-C₄-haloalkoxy,
R¹⁶ represents hydrogen or C₁-C₄-alkyl,
R¹⁹ represents hydrogen; optionally cyano-, hydroxyl-, halogen-, or C₁-C₄-alkoxy-substituted C₁-C₆-alkyl; optionally cyano- or halogen-substituted C₃-C₆-alkenyl or C₃-C₆-alkynyl; or optionally cyano-, halogen-, or C₁-C₄-alkyl-substituted C₃-C₆-cycloalkyl, and
R²⁰ represents hydrogen; optionally cyano-, hydroxyl-, halogen-, or C₁-C₄-alkoxy-substituted C₁-C₆-alkyl; optionally cyano- or halogen-substituted C₃-C₆-alkenyl or C₃-C₆-alkynyl; optionally cyano-, halogen-, or C₁-C₄-alkyl-substituted C₃-C₆-cycloalkyl; or
optionally nitro-, cyano-, halogen-, C₁-C₄-alkyl-, C₁-C₄-haloalkyl-, C₁-C₄-alkoxy-, or C₁-C₄-haloalkoxy-substituted phenyl, or R²⁰ together with R¹⁹ represents optionally C₁-C₄-alkyl-substituted C₂-C₆-alkanediyl or C₂-C₅-oxaalkanediyl.

11. The composition according to claim 10 wherein
W represents hydrogen, halogen, C₁-C₆-alkyl, C₁-C₆-haloalkyl, or C₁-C₆-alkoxy,
X represents halogen, C₁-C₆-alkyl, C₂-C₆-alkenyl, C₂-C₆-alkynyl, C₁-C₆-haloalkyl, C₁-C₆-alkoxy, C₃-C₆-alkenyloxy, C₁-C₆-haloalkoxy, C₃-C₆-haloalkenyloxy, nitro, or cyano,
Y represents hydrogen, halogen, C₁-C₄-alkyl, C₁-C₂-haloalkyl, C₁-C₂-haloalkoxy, or cyano, or represents a radical 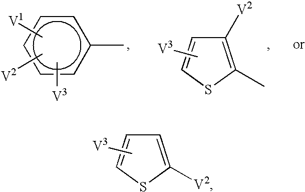
in which
V¹ represents hydrogen, halogen, C₁-C₁₂-alkyl, C₁-C₆-alkoxy, C₁-C₄-haloalkyl, C₁-C₄-haloalkoxy, nitro, or cyano, and
V² and V³ independently of one another represent hydrogen, halogen, C₁-C₆-alkyl, C₁-C₆-alkoxy, C₁-C₄-haloalkyl, or C₁-C₄-haloalkoxy, and
CDC represents one of the groups 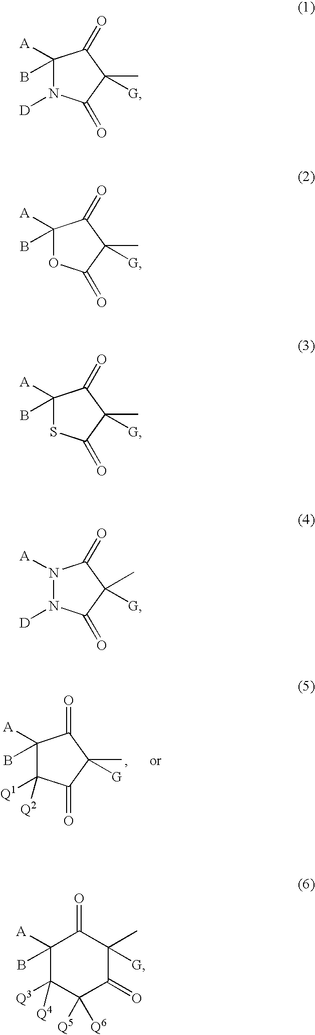
in which
A represents hydrogen; optionally halogen-substituted C₁-C₁₂-alkyl, C₃-C₈-alkenyl, C₁-C₁₀-alkoxy-C₁-C₈-alkyl, or C₁-C₁₀-alkylthio-C₁-C₆-alkyl; optionally halogen-, C₁-C₆-alkyl-, or C₁-C₆-alkoxy-substituted C₃-C₈-cycloalkyl in which one or two ring members that are not directly adjacent are optionally replaced by oxygen and/or sulfur; or optionally halogen-, C₁-C₆-alkyl-, C₁-C₆-haloalkyl-, C₁-C₆-alkoxy-, C₁-C₆-halo-alkoxy-, cyano-, or nitro-substituted phenyl or phenyl-C₁-C₆-alkyl,
B represents hydrogen, C₁-C₁₂-alkyl, or C₁-C₈-alkoxy-C₁-C₆-alkyl, or A, B, and the carbon atom to which they are attached represent
(i) saturated C₃-C₁₀-cycloalkyl or unsaturated C₅-C₁₀-cycloalkyl in which one ring member is optionally replaced by oxygen or sulfur and that are optionally mono- or disubstituted by C₁-C₈-alkyl, C₃-C₁₀-cycloalkyl, C₁-C₈-haloalkyl, C₁-C₈-alkoxy, C₁-C₈-alkylthio, halogen, or phenyl,
(ii) C₅-C₆-cycloalkyl that is substituted by an alkylenedioxyl or an alkylenedithioyl group or by an alkylenediyl group that optionally contains one or two oxygen and/or sulfur atoms that are not directly adjacent and that is optionally substituted by C₁-C₄-alkyl, wherein the alkylenedioxyl, alkylenedithioyl, or alkylenediyl group, together with the carbon atom to which it is attached, forms a further five- to eight-membered ring, or
(iii) C₃-C₈-cycloalkyl or C₅-C₈-cycloalkenyl in which two substituents together with the carbon atoms to which they are attached represent optionally C₁-C₆-alkyl-, C₁-C₆-alkoxy-, or halogen-substituted C₂-C₆-alkanediyl, C₂-C₆-alkenediyl, or C₄-C₆-alkane-dienediyl in which one methylene group is optionally replaced by oxygen or sulfur,
D represents hydrogen; optionally halogen-substituted C₁-C₁₂-alkyl, C₃-C₈-alkenyl, C₃-C₈-alkynyl, or C₁-C₁₀-alkoxy-C₂-C₈-alkyl; optionally halogen-, C₁-C₄-alkyl-, C₁-C₄-alkoxy-, or C₁-C₄-haloalkyl-substituted C₃-C₈-cycloalkyl in which one ring member is optionally replaced by oxygen or sulfur; or optionally halogen-, C₁-C₆-alkyl-, C₁-C₆-haloalkyl-, C₁-C₆-alkoxy-, C₁-C₆-haloalkoxy-, cyano-, or nitro-substituted phenyl or phenyl-C₁-C₆-alkyl, or
A and D together represent optionally substituted C₃-C₆-alkanediyl or C₃-C₆-alkenediyl in which one methylene group is optionally replaced by a carbonyl group, oxygen, or sulfur, wherein the optional substituents are halogen, hydroxyl, mercapto, or optionally halogen-substituted C₁-C₁₀-alkyl or C₁-C₆-alkoxy, or are a C₃-C₆-alkanediyl grouping, C₃-C₆-alkene-diyl grouping, or a butadienyl grouping that is optionally substituted by C₁-C₆-alkyl or in which two adjacent substituents together with the carbon atoms to which they are attached optionally form a further saturated or unsaturated cycle having 5 or 6 ring atoms and optionally contain oxygen or sulfur,
with the proviso that when CDC represents the group 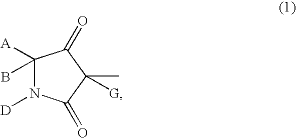
then A and D together with the atoms to which they are attached represent the groups AD-1 to AD-10 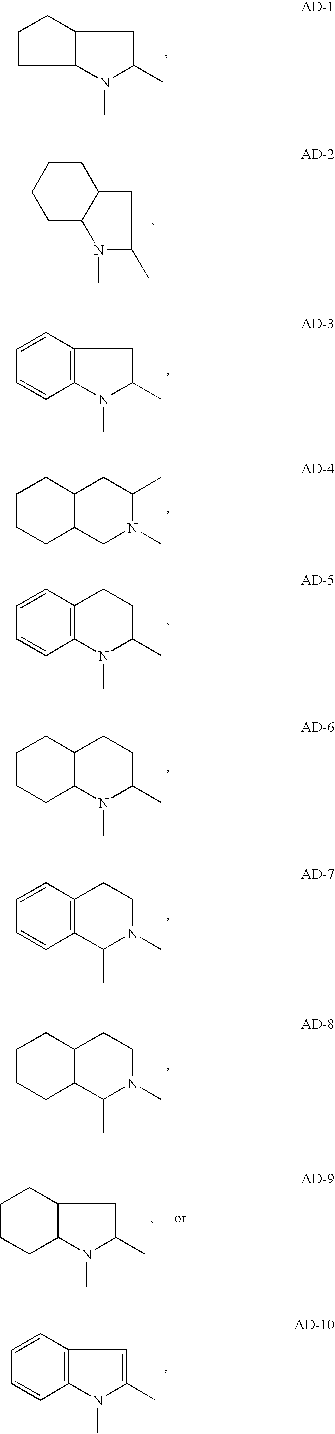
Q¹ represents hydrogen or C₁-C₄-alkyl, or
A and Q¹ together represent C₃-C₆-alkanediyl or C₄-C₆-alkenediyl that is also bridged by a C₁-C₂-alkanediyl group or by an oxygen atom, each of which radicals is optionally mono- or disubstituted by identical or different halogens, by C₁-C₁₀-alkyl, C₁-C₆-alkoxy, C₁-C₆-alkylthio, or C₃-C₇-cycloalkyl each of which is optionally mono- to trisubstituted by identical or different halogens, or by benzyloxy or phenyl, each of which is optionally mono- to trisubstituted by identical or different substituents selected from the group consisting of halogen, C₁-C₆-alkyl, and C₁-C₆-alkoxy,
Q²Q⁴, Q⁵, and Q⁶ independently of one another represent hydrogen or C₁-C₄-alkyl,
Q³ represents hydrogen, C₁-C₆-alkyl, C₁-C₆-alkoxy-C₁-C₂-alkyl, or C₁-C₆-alkylthio-C₁-C₂-alkyl; optionally halogen-, C₁-C₄-alkyl- or C₁-C₄-alkoxy-substituted C₃-C₈-cycloalkyl in which one methylene group is optionally replaced by oxygen or sulfur; or optionally halogen-, C₁-C₄-alkyl-, C₁-C₄-alkoxy-, C₁-C₂-haloalkyl-, C₁-C₂-haloalkoxy-, cyano-, or nitro-substituted phenyl, or
Q³ and Q⁴ together with the carbon atom to which they are attached represent an optionally C₁-C₄-alkyl-, C₁-C₄-alkoxy-, or C₁-C₄-alkoxy- or C₁-C₂-haloalkyl-substituted C₃-C₇-ring in which one ring member is optionally replaced by oxygen or sulfur, and
G represents chlorine, bromine, or nitro.

12. The composition according to claim 10 wherein
W represents hydrogen, chlorine, bromine, C₁-C₃-alkyl, or C₁-C₃-alkoxy,
X represents chlorine, bromine, C₁-C₄-alkyl, C₁-C₄-alkoxy, C₁-C₃-haloalkyl, C₁-C₃-haloalkoxy, or cyano,
Y represents hydrogen, chlorine, bromine, C₁-C₂-alkyl, or trifluoromethyl, or represents a radical 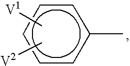
in which
V¹ represents hydrogen, fluorine, chlorine, bromine, C₁-C₆-alkyl, C₁-C₄-alkoxy, C₁-C₂-haloalkyl, C₁-C₂-haloalkoxy, nitro, or cyano, and
V² represents hydrogen, fluorine, chlorine, bromine, C₁-C₄-alkyl, C₁-C₄-alkoxy, C₁-C₂-haloalkyl, or C₁-C₂-haloalkoxy, and
CDC represents one of the groups 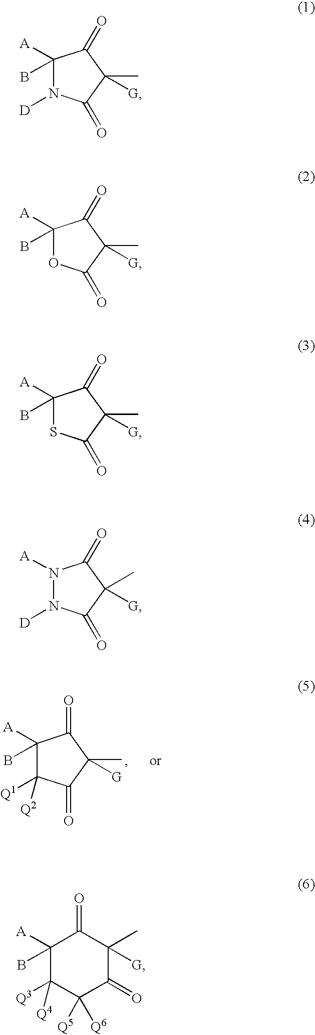
in which
A represents hydrogen; C₁-C₆-alkyl or C₁-C₄-alkoxy-C₁-C₂-alkyl, each of which is optionally mono- to trisubstituted by fluorine or chlorine; or C₃-C₇-cycloalkyl that is optionally mono- to disubstituted by fluorine, chlorine, C₁-C₂-alkyl, or C₁-C₂-alkoxy
B represents hydrogen or C₁-C₆-alkyl, or
A, B, and the carbon atom to which they are attached represent
(i) saturated C₃-C₇-cycloalkyl in which one ring member is optionally replaced by oxygen or sulfur and that is optionally monosubstituted by C₁-C₄-alkyl, C₁-C₂-haloalkyl, or C₁-C₄-alkoxy, with the proviso that Q³ represents hydrogen or methyl,
(ii) C₅-C₆-cycloalkyl that is substituted by an alkylenediyl or by an alkylenedioxyl group that optionally contains one or two oxygen or sulfur atoms that are not directly adjacent and that is optionally substituted by methyl or ethyl, wherein the alkylene-diyl or alkylenedioxyl group, together with the carbon atom to which it is attached, forms a further five- or six-membered ring, with the proviso that Q³ represents hydrogen or methyl, or
(iii) C₃-C₆-cycloalkyl or C₅-C₆-cycloalkenyl in which two substituents together with the carbon atoms to which they are attached represent butadienediyl or C₂-C₄-alkanediyl or C₂-C₄-alkenediyl in which one methylene group is optionally replaced by oxygen and that are optionally monosubstituted by methyl or methoxy, with the proviso that Q³ represents hydrogen or methyl,
D represents hydrogen; C₁-C₆-alkyl, C₃-C₆-alkenyl, or C₁-C₄-alkoxy-C₂-C₃-alkyl, each of which is optionally mono- to trisubstituted by fluorine or chlorine; C₃-C₇-cycloalkyl that is optionally monosubstituted by C₁-C₂-alkyl, C₁-C₂-alkoxy, or trifluoromethyl and in which one methylene group is optionally replaced by oxygen or sulfur; or, except when CDC represents the group 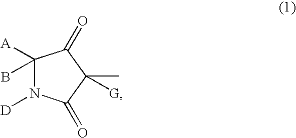
D represents phenyl, pyridyl, or benzyl, each of which is optionally mono- to disubstituted by fluorine, chlorine, bromine, C₁-C₄-alkyl, C₁-C₂-haloalkyl, C₁-C₄-alkoxy, or C₁-C₂-haloalkoxy, or
A and D together represent optionally substituted C₃-C₅-alkanediyl in which one methylene group is optionally replaced by oxygen or sulfur and the optional substituent is C₁-C₂-alkyl; or, when CDC represents the group 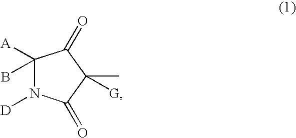
A and D together with the atoms to which the are attached optionally represent one of the groups AD-1 to AD-10 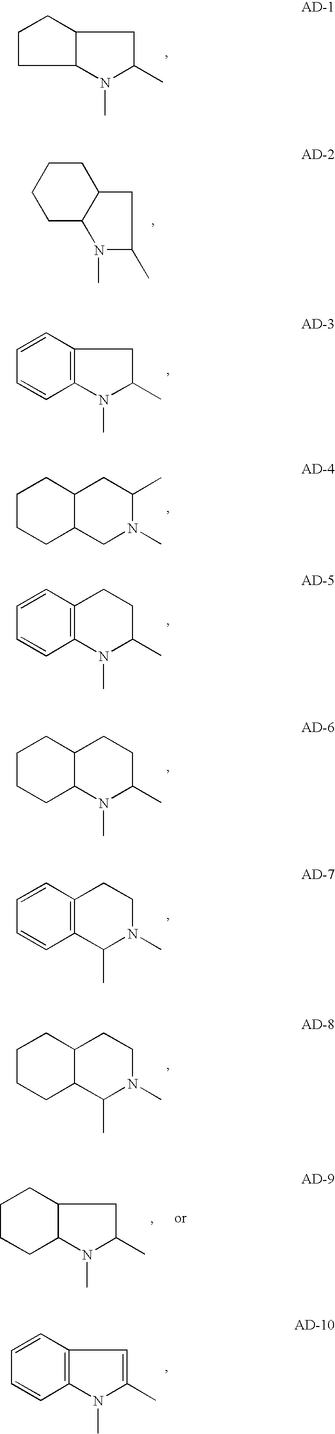
Q represents hydrogen, or
A and Q¹ together represent C₃-C₄-alkanediyl or C₃-C₄-alkenediyl, each of which is optionally mono- or disubstituted by identical or different substituents selected from the group consisting of C₁-C₂-alkyl and C₁-C₂-alkoxy,
Q² represents hydrogen,
Q⁴, Q⁵ and Q⁶ independently of one another represent hydrogen or C₁-C₂-alkyl,
Q³ represents hydrogen, C₁-C₄-alkyl, C₁-C₄-alkoxy-C₁-C₂-alkyl, or C₁-C₄-alkylthio-C₁-C₂-alkyl; or optionally methyl- or methoxy-substituted C₃-C₆-cycloalkyl in which one methylene group is optionally replaced by oxygen or sulfur, or
Q³ and Q⁴ together with the carbon to which they are attached represent a saturated C₅-C₆-ring that is optionally mono- to disubstituted by C₁-C₄-alkyl or C₁-C₄-alkoxy and in which one ring member is optionally replaced by oxygen or sulfur, with the proviso that A represents hydrogen or methyl, and
G represents chlorine or nitro.

13. The composition according to claim 10 wherein
W represents hydrogen, chlorine, bromine, methyl, ethyl, methoxy, or ethoxy,
X represents chlorine, bromine, methyl, ethyl, propyl, methoxy, ethoxy, trifluoromethyl, difluoromethoxy, trifluoromethoxy, or cyano,
Y represents hydrogen, chlorine, bromine, methyl, or trifluoromethyl, or represents a radical 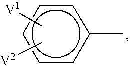
in which
V represents hydrogen, fluorine, chlorine, bromine, methyl, ethyl, tert-butyl, methoxy, trifluoromethyl, or trifluoromethoxy, and
V² represents hydrogen, fluorine, chlorine, methyl, methoxy, or trifluoro-methyl, and
CDC represents one of the groups 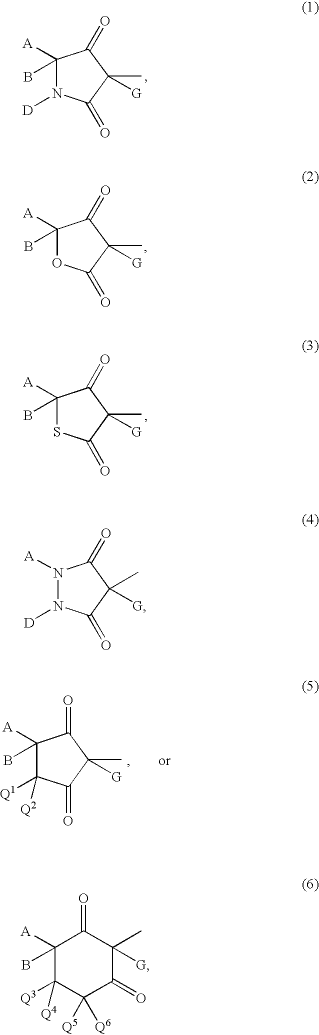
in which
A represents hydrogen; C₁-C₄-alkyl or C₁-C₂-alkoxy-C₁-C₂-alkyl, each of which is optionally mono- to trisubstituted by fluorine; C₃-C₆-cycloalkyl that is optionally monosubstituted by fluorine, methyl, or methoxy,
B represents hydrogen, methyl, or ethyl, or
A, B, and the carbon atom to which they are attached represent
(i) saturated C₅-C₆-cycloalkyl in which one ring member is optionally replaced by oxygen and that is optionally mono-substituted by methyl, trifluoromethyl, methoxy, ethoxy, propoxy, butoxy, or isobutoxy, with the proviso that Q³ represents hydrogen, or
(ii) C₅-C₆-cycloalkyl that is substituted by an alkylenedioxyl group that contains two oxygen atoms that are not directly adjacent, with the proviso that Q³ represents hydrogen,
D represents hydrogen; C₁-C₄-alkyl, C₃-C₄-alkenyl, C₁-C₂-alkoxy-C₂-C₃-alkyl, or C₃-C₆-cycloalkyl in which one methylene group is optionally replaced by oxygen or sulfur, each of which radicals is optionally mono-to trisubstituted by fluorine; or, except when CDC represents the group 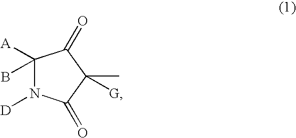
D represents phenyl or pyridyl, each of which is optionally mono- to disubstituted by fluorine, chlorine, bromine, methyl, ethyl, n-propyl, isopropyl, methoxy, ethoxy, trifluoromethyl, or trifluoromethoxy, or
A and D together represent optionally substituted C₃-C₅-alkanediyl in which one carbon atom is optionally replaced by oxygen or sulfur and that is optionally mono- or disubstituted by methyl; or when CDC represents the group 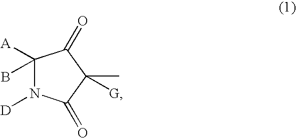
A and D together with the atoms to which they are attached optionally represent the group 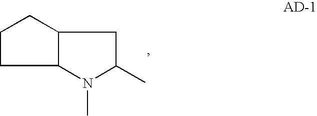
Q¹ represents hydrogen, or
A and Q¹ together represent C₃-C₄-alkanediyl that is optionally mono- or disubstituted by methyl or methoxy, or
Q² represents hydrogen,
Q⁴, Q⁵ and independently of one another represent hydrogen or methyl,
Q³ represents hydrogen, methyl, ethyl, or C₃-C₆-cycloalkyl, or
Q³ and Q⁴ together with the carbon to which they are attached represent a saturated C₅-C₆-ring that is optionally monosubstituted by methyl or methoxy and in which one ring member is optionally replaced by oxygen or sulfur, with the proviso that A represents hydrogen, and
G represents chlorine and nitro.

14. The composition according to claim 10 in which the crop plant compatibility-improving compound is selected from the group consisting of cloquintocet-mexyl, fenchlorazole-ethyl, isoxadifen-ethyl, mefenpyr-diethyl, furilazole, fenclorim, cumyluron, dymron, the compound 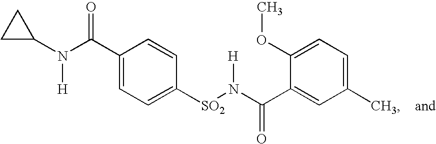
the compound

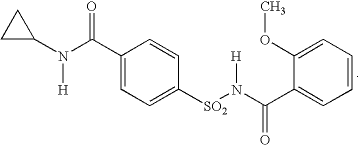

15. The composition according to claim 10 in which the crop plant compatibility-improving compound is cloquintocet-mexyl or mefenpyr-diethyl.

16. A method for controlling unwanted vegetation comprising allowing an effective amount of a composition according to claim 10 to act on the unwanted vegetation or its habitat.

17. A method for controlling unwanted vegetation comprising allowing a cyclic dicarbonyl compounds of formula (I) according to claim 10 and a crop plant compatibility-improving compound according to claim 10 to act on the unwanted vegetation or its habitat separately, one being applied son after the other.
